(19) United States
(12) Patent Application Publication
(10) Pub. No.: US 2008/0134236 A1
(43) Pub. Date: Jun. 5, 2008

(54) Method and apparatus for controlling reproduction of advertisements

(76) Inventors: Akio Iijima, Tokyo (JP); Akihiko Kai, Tokyo (JP); Takeshi Arimura, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,859

(22) Filed: Jan. 16, 2008

Related U.S. Application Data
(62) Division of application No. 09/959,885, filed on Nov. 9, 2001.

(30) Foreign Application Priority Data
Feb. 29, 2000 (JP) 53305/2000

(51) Int. Cl. H04N 7/10

(52) U.S. Cl. 725/34

(57) ABSTRACT

A method and an apparatus for reproducing advertisement data stored on a receiving side, and a recording medium for recording reproduction procedures are provided. Weighting for priority of reproduction with respect to each of a plurality of pieces of advertisement data stored on the receiving side is executed, a priority order of reproduction of each piece of advertisement data on a receiver is determined based on the weighting, and the stored advertisement data is reproduced in accordance with the priority order in response to an advertisement data reproduction command.

This is a Divisional Application of U.S. patent application Ser. No. 09/959,885, which is the national stage of International Application No. PCT/JP00/01897, filed Mar. 28, 2000.

### FIELD OF THE INVENTION

The present invention relates to a method and an apparatus for controlling reproduction of advertisements stored in a storage device in a receiving side, and a recording medium storing a computer program for causing a computer to execute procedures similar to those of the method.

### DESCRIPTION OF THE RELATED ART

Conventionally, an advertisement displaying technology has been proposed; wherein a receiver for receiving broadcast signals including program (show) signals is provided with a storage part; advertisements, which are planned to be inserted in a program (show), are collectively transmitted to each receiver in advance or they are delivered by mailing or the like to each receiver in advance, and are stored in the storage part of the receiver; and the stored advertisements are read out at a predetermined timing to display them on the receiver.

Moreover, as an improvement of the above advertisement displaying technology, an advertisement displaying technology has been proposed which allows the audience of each receiver to selectively store advertisements suitable for the audience and to display the advertisement.

In the above advertisement displaying technology with which advertisements are selectively stored and displayed as desired on a receiver, each sponsor adds data specifying an audience group targeted by an advertisement, for example, data for specifying age, sex, hobbies and the like of the targeted audience group, to the data of the advertisement which will be transmitted or delivered. On the receiving side, an audience stores individual (or personal) data specifying an audience group to which the audience belongs, for example, data such as age, sex and hobbies or the like of the audience, on the receiver in advance.

When the receiver receives or installs the advertisement data and data added to it, the receiver compares the data added to each piece of advertisement data and the personal data stored on the receiver. If the additional data and the personal data coincide (or partially coincide) with each other, the receiver stores the advertisement data in the storage part. If the additional data and the personal data do not coincide with each other, the receiver discards the advertisement data without storing it. Therefore, only an advertisement with a high degree of coincidence (matching) between an audience group targeted by the advertisement and an audience group to which the audience belongs is stored. Alternatively, the above advertisement data is delivered to the audience side by mailing or the like in advance, and the audience stores desired advertisements on the receiver.

The receiver simply reads out and displays the selectively stored advertisement data sequentially, in the order in which each piece of the data was stored, at a predetermined timing.

However, when an order for an advertisement is received from a sponsor, it is a common practice for the sponsor to take the publicity effect of the advertisement into consideration and to purchase a frame for displaying the advertisement, regardless of the viewing/listening period (displaying period) of the advertisement and receivers.

Thus, concerning an advertisement for which the designated display period is short or an advertisement for which a remaining display period is short, it is necessary to increase the displaying frequency on each receiver in order to attain a predetermined total number of display during the period. That is, it is necessary to preferentially read out and display an advertisement for which the remaining display period is short.

It is necessary to prepare on the host side a confirming mechanism in order to ascertain the status of the display within a predetermined period.

In addition, concerning an advertisement whose ordered total number of display is large or an advertisement for which the remaining number of display until the total number of display is reached is large, it is necessary to increase a frequency of displaying the advertisement on each receiver in order to attain the total number of display within the predetermined period. That is, it is necessary to preferentially read out and display an advertisement for which the remaining number of display is large.

The averaged number of displays of an advertisement that is at least required in each of all receivers in order to attain the ordered total number of displays of an advertisement (averaged minimum display number, i.e., a minimum number of displays required in each receiver in order to attain the ordered total number of display of the advertisement) can be calculated by dividing the ordered total number of displays of the advertisement by the total number of receivers. That is, in order to complete a predetermined total number of displays within a predetermined period, it is necessary to increase the frequency of displays of an advertisement for which the remaining number of displays until the averaged minimum display number is reached is large, on each receiver. However, some advertisements are not stored on a receiver which selectively stores advertisements and displays stored advertisements. That is, for each advertisement, the number of receivers on which the advertisement is stored is different. Therefore, if even one receiver does not store the advertisement, even if all the other receivers storing the advertisement attain the averaged minimum display number, the total number of display cannot be attained. In addition, even if an advertisement is stored in all the receivers, if certain receivers could not complete the minimum averaged display number, the ordered total number of displays cannot be attained. In order to supplement the shortage of the number of displays, it is necessary to perform a larger number of displays in the other receivers. In addition, it is necessary to prevent the number of displays in a specific receiver from becoming too large. Thus, it is necessary to determine, based on the minimum average number of displays, the number of displays that is equally assigned to each receiver which stores a specific advertisement, that provides each receiver with room (scope) to offset a shortage of the number of displays of the advertisement, and that defines an upper limit on the number of displays of the advertisement on each receiver in order to avoid an excessive numbers of display of the advertisement (hereinafter, this number of display is referred to the an averaged display number). Then, it is necessary to use the averaged display number instead of the above averaged minimum display number to preferentially read out and display an advertisement for which the remaining number of displays until this averaged display number is reached is large. Thus, in order to complete a predetermined total number of display within a predetermined period, it is necessary to increase the frequency of displaying an advertisement for which the remaining number of display until the averaged display number is reached is large.

In addition, in the storage part of the above conventional receiver, an advertisement for which information specifying an audience group targeted by the advertisement and information specifying an audience group to which an audience of the receiver belongs coincide each other is stored. However, the degree of coincidence (matching) varies for each stored advertisement. That is, an advertisement most suitable for the audience of the receiver, an advertisement moderately suitable for the audience and an advertisement less suitable for the audience may be included in the stored advertisements. If effects and efficiency of an advertisement are taken into consideration, it is desirable to preferentially read out and display advertisements with a high degree of coincidence.

In addition, in the method of displaying stored advertisements one after another in the stored order, as in the above conventional receiver, advertisements are always repeatedly displayed in the same order. In addition, if a method in which a priority order of displaying each advertisement is calculated each time one advertisement is displayed and advertisement is displayed in the order from one with a highest priority order, the same advertisement may be, potentially, sequentially displayed. However, if advertisements are always displayed in the same order or the identical advertisement is continuously displayed, an audience's attention cannot be drawn. That is, if the effects and efficiency of an advertisement are taken into consideration, it is not preferable to always display advertisements in the same order or to continuously display the same advertisement. Therefore, it is desired that a new order of display is predetermined after displaying advertisements in a certain order, and advertisements are displayed in accordance with the predetermined display order.

In addition, the value of the above averaged display number is the same for each receiver storing certain advertisements. That is, the degree of coincidence of information specifying an audience group targeted by an advertisement and information specifying an audience group to which an audience of a receiver belongs is not reflected at all. If efficiency of an advertisement is taken into consideration, it is not desirable to assign the same number of displays to both an audience with a low degree of coincidence with the advertisement and an audience with a high degree of coincidence with the advertisement. Thus, it is necessary to set the number of displays to reflect a degree of coincidence between an advertisement and an audience, making each receiver offset a shortage of the number of displays of the advertisement while not allowing a certain advertisement to be displayed too many times on each receiver. Then, it is necessary to use that display number, that is, the number of displays determined for each receiver according to the degree of coincidence (hereinafter referred to as an upper limit display number), instead of the above averaged display number, to preferentially read out and display an advertisement which has a large upper limit display number.

Moreover, it is necessary to coincide the display time of an advertisement to the time of lifestyle of the audience targeted by the advertisement as much as possible, and preferentially read out and display the advertisement during the matched time slot.

In addition, for an advertisement, attributes such as cars, medical products, foods and the like (that is, a field to which a good advertised by an advertisement belongs) exist, and tastes with respect to the attributes exist on the audience side. It is necessary that an audience performs voting with respect to the attributes which he/she prefers, whereby an advertisement with an audience-preferred attribute is preferentially read out and displayed.

In addition, when an advertisement that should be preferentially displayed is determined, an advertisement that would not be selected as most preferential in a comprehensive determination may be selected in some cases, if determination is performed based on one element of determination. Therefore, it is desired that an advertisement that should be most preferentially displayed is comprehensively determined based on a plurality of elements of determination.

In addition, it is also necessary to receive feedback from the receiver, thereby changing the above conditions of setting on occasion, and controlling display of an advertisement from the transmitting side.

Moreover, it is desired to have a mechanism for displaying, corresponding to a designated broadcast program, a specific advertisement according to a request from the sponsor. In this mechanism, a designated advertisement is displayed if the advertisement is distributed and stored, and, preferably, an advertisement is selected out of the other advertisements to be displayed in accordance with the above conditions if the designated advertisement is not distributed and stored.

Therefore, it is an object of the present invention to provide an advertisement data reproducing method and an advertisement data reproducing apparatus for performing control such that a priority order of display of each advertisement is determined based on a displaying period of each advertisement stored on each receiving side, and advertisements are displayed in accordance with the priority order; and a recording medium for storing a computer program for causing a computer to execute procedures similar to those of the above method.

It is another object of the present invention to provide an advertisement data reproducing method and an advertisement data reproducing apparatus for performing control such that a priority order of displaying each advertisement is determined based on an averaged display number (the remaining number of display until an averaged display number is reached) of each advertisement stored on each receiving side, and advertisements are displayed in accordance with the priority order; and a recording medium for storing a computer program for causing a computer to execute procedures similar to those of the above method.

It is another object of the present invention to provide an advertisement data reproducing method and an advertisement data reproducing apparatus for performing control such that a priority order of displaying each advertisement is determined based on a degree of coincidence between the audience group targeted by each advertisement stored on each receiving side and the audience group of an audience of a receiver, and advertisements are displayed in accordance with the priority order; and a recording medium for storing a computer program for causing a computer to execute procedures similar to those of the above method.

It is another object of the present invention to provide an advertisement data reproducing method and an advertisement data reproducing apparatus for performing control such that a predetermined display order is assigned to each advertisement stored on each receiving side to display advertisements in accordance with the order, and a new predetermined display order is assigned after displaying the advertisements, for displaying advertisements in accordance with the new order; and a recording medium for storing a computer program for causing a computer to execute procedures similar to those of the above method.

It is another object of the present invention to provide an advertisement data reproducing method and an advertisement data reproducing apparatus for performing control such that each advertisement stored on each receiving side is preferentially displayed in accordance with the time schedule of living of the audience belonging to an audience group targeted by the advertisement; and a recording medium for storing a computer program for causing a computer to execute procedures similar to those of the above method.

It is another object of the present invention to provide an advertisement data reproducing method and an advertisement data reproducing apparatus for performing control such that an audience of a receiver can indicate tastes (preferences) with respect to an attribute of each advertisement stored on a receiving side, a priority order of displaying each advertisement is determined based on the taste with respect to the attribute of the advertisement indicated by the audience, and advertisements are displayed in accordance with the priority order; and a recording medium for storing a computer program for causing a computer to execute procedures similar to those of the above method.

It is another object of the present invention to provide an advertisement data reproducing method and an advertisement data reproducing apparatus for performing control such that the number of display of an advertisement (upper limit display number), which is required for each receiver and which reflects a degree of coincidence between the audience group targeted by each advertisement and the audience group of an audience of a receiver, is determined, a priority order of displaying each advertisement is determined based on the upper limit display number (the remaining number of display until the upper limit display number is reached) of each advertisement stored on each receiving side, and advertisements are displayed in accordance with the priority order; and a recording medium for storing a computer program for causing a computer to execute procedures similar to those of the above method.

It is another object of the present invention to provide an advertisement data reproducing method and an advertisement data reproducing apparatus for performing control such that a plurality of elements for determining a priority order are comprehensively determined to give a priority order to each advertisement, and advertisements are displayed in accordance with the priority order; and a recording medium for storing a computer program for causing a computer to execute procedures similar to those of the above method.

It is another object of the present invention to provide an advertisement data reproducing method and an advertisement data reproducing apparatus for performing control such that histories, which are actual results indicating that an advertisement is displayed on a receiver, are collected, and display control of the receiver is applied by a transmitting side based on the accumulated results; and a recording medium for storing a computer program for causing a computer to execute procedures similar to those of the above method.

It is another object of the present invention to provide an advertisement data reproducing method and an advertisement data reproducing apparatus for performing control such that designation of an advertisement that should be most preferentially displayed is made possible, and if the designated advertisement is stored on a receiving side, the advertisement is most preferentially displayed; and a recording medium for storing a computer program for causing a computer to execute procedures similar to those of the above method.

### SUMMARY OF THE INVENTION

An advertisement data reproducing method of the present invention comprises, in an advertisement data reproducing method wherein advertisement data for a plurality of advertisements is stored at an audience side and the stored advertisement data is reproduced on a receiver, the steps of: for the advertisement data of each advertisement, conducting weighting with respect to the priority for reproducing the advertisement data; based on the weight, determining a priority order of the advertisement data of the respective advertisements for reproducing the advertisement data on the receiver; and, in response to a command to reproduce the advertisement data, reproducing the stored advertisement data of respective advertisements in accordance with the priority order.

An advertisement data reproducing method of the present invention comprises, in the above advertisement data reproducing method, the steps of: (1) for the advertisement data of each advertisement, adding data indicative of a viewing/listening period for the advertisement data, (2) based on the viewing/listening period, determining a remaining viewing/listening period for the advertisement data of the advertisement, (3) for the remaining viewing/listening period, determining the value of a coefficient representing a weight, wherein the weight becomes greater as the remaining viewing/listening period becomes shorter, and (4) based on the value of the coefficient, determining a priority order for reproducing the stored advertisement data of respective advertisements on the receiver.

An advertisement data reproducing method of the present invention comprises, in the above advertisement data reproducing method, the steps of: (1) for each advertisement, selecting, from category data for specifying audience groups, categories which specify audience groups which are targets of the advertisement, wherein the category data for specifying audience groups comprises a plurality of items and each item comprises a plurality of categories of audience groups; assigning the value of a coefficient representing a weight to each of the selected categories, wherein a greater weight is assigned to a category having more importance; and adding, to the advertisement data of the advertisement, first data which represents the selected categories and data which represents the values of the coefficients assigned to each of the selected categories, (2) selecting, from the category data for specifying audience groups, categories which specify audience groups to which the audience of the receiver belongs; and storing, at the audience side, second data which represents the selected categories, (3) based on the assigned coefficient values of the selected categories among the first data which coincide with the selected categories represented by the second data, determining the value of a coefficient which represents the degree of coincidence between the categories targeted by the advertisement and the categories to which the audience belongs, and (4) based on the value of the coefficient representing the degree of coincidence, determining a priority order for reproducing the stored advertisement data of respective advertisements on the receiver.

An advertisement data reproducing method of the present invention comprises, in the above advertisement data reproducing method, the steps of: (1) for the advertisement data of each advertisement, adding data indicative of the number of reproductions of the advertisement data, (2) based on the number of reproductions, determining a remaining number of reproduction of the advertisement data of the advertisement, (3) for the remaining number of reproduction, determining a value of a coefficient representing a weight, wherein the weight becomes greater as the remaining number of reproduction becomes larger, and (4) based on the value of the coefficient, determining a priority order for reproducing the stored advertisement data of respective advertisements on the receiver.

An advertisement data reproducing method of the present invention is characterized in that, in the above advertisement data reproducing method, the number of reproductions in the step (1), which adds data indicative of the number of reproductions of the advertisement data, defines an upper limit of the number of reproduction of the advertisement on the receiver, and is an averaged reproduction number which is assigned equally to each receiver which stores the advertisement.

An advertisement data reproducing method of the present invention is characterized in that, in the above advertisement data reproducing method, the number of reproductions in the step (1), which adds data indicative of the number of reproductions of the advertisement data, defines an upper limit of the number of reproductions of the advertisement on the receiver, and is a reproduction number which is assigned individually to each receiver which stores the advertisement and which is derived based on a degree of coincidence between an audience group targeted by the advertisement and an audience group to which the audience of the receiver belongs.

An advertisement data reproducing method of the present invention comprises, in the above advertisement data reproducing method, the steps of: (1) among the stored advertisement data of the respective advertisements, detecting advertisement data which has been reproduced, (2) for advertisement data of each stored advertisement, determining the value of a coefficient representing a weight, wherein the weight is determined so as to provide the detected advertisement data of the advertisement with a lower rank in a predetermined reproduction order of advertisements than the advertisement data of the advertisements which are waiting for reproduction, and (3) based on the value of the coefficient, determining a priority order for reproducing the stored advertisement data of respective advertisements.

An advertisement data reproducing method of the present invention comprises, in the above advertisement data reproducing method, the steps of: (1) for advertisement data of each advertisement, selecting time slot data from preferential display time data which comprises time slot data for each of a plurality of time slots, for specifying one or more times of day at which the advertisement is desired to be preferentially reproduced; assigning the value of a coefficient representing a weight to the selected time slot data, wherein a greater weight is assigned to a selected time slot having more importance; and adding, to the advertisement data of the advertisement, the selected time slot data and data which represents the value of the coefficient assigned to the time slot data, (2) determining a time slot to which the present time of day belongs, (3) reading out the value of the coefficient assigned to the time slot data which corresponds to the time slot determined in the step (2), and (4) based on the value of the coefficient, determining a priority order for reproducing the stored advertisement data of respective advertisements on the receiver.

An advertisement data reproducing method of the present invention comprises, in the above advertisement data reproducing method, the steps of: (1) for advertisement data of each advertisement, selecting advertisement attribute data representative of a category to which an object to be advertised by the advertisement belongs; and adding the selected advertisement attribute data to the advertisement data, (2) for the advertisement attribute data, assigning the value of a coefficient which represents importance of the category represented by the advertisement attribute data, (3) if needed, increasing or decreasing the value of the coefficient assigned to the advertisement attribute data by the audience of the receiver, and (4) based on the value of the coefficient, determining a priority order for reproducing the stored advertisement data of respective advertisements on the receiver.

An advertisement data reproducing method of the present invention is characterized in that, in the above advertisement data reproducing method, the step of determining a priority order for reproducing the stored advertisement data of respective advertisements on the receiver comprises a step of changing the value of the coefficient by applying thereto the value of a different coefficient.

An advertisement data reproducing method of the present invention comprises, in an advertisement data reproducing method wherein advertisement data for a plurality of advertisements is stored at an audience side and the stored advertisement data is reproduced on a receiver, the steps of: for the advertisement data of each advertisement, adding identification data to identify the advertisement data; conducting weighting with respect to the priority for reproducing the advertisement data; based on the weight, determining a priority order of the advertisement data for the respective advertisements for reproducing the advertisement data on the receiver; and, in response to a command to instruct reproduction of the advertisement data, reproducing the stored advertisement data of respective advertisements in accordance with the priority order; wherein if the identification data is included in the command to instruct reproduction of the advertisement data, in response thereto, the advertisement data which is identified by the identification data among the stored advertisement data of advertisements is most-preferentially reproduced.

An advertisement data reproducing apparatus of the present invention comprises, in an advertisement data reproducing apparatus wherein advertisement data for a plurality of advertisements is stored at the audience side and the stored advertisement data is reproduced on a receiver: (A) means for conducting, for the advertisement data of each advertisement, weighting regarding priority for reproducing the advertisement data, and determining the value of a coefficient representing the weight in such a manner that the weight becomes greater as the priority becomes higher, (B) means for associating and storing the advertisement data of each advertisement and the value of the coefficient corresponding to the advertisement data, (c) means for determining the priority order of the advertisement data of the respective advertisements for reproducing the advertisement data on the receiver, based on the value of the coefficient, and (D) means, in response to a command to instruct reproduction of the advertisement data, for reading out and reproducing the stored advertisement data of respective advertisements in accordance with the priority order.

An advertisement data reproducing apparatus of the present invention is characterized in that, in the above advertisement data reproducing apparatus, the means of said item (A) comprises: (1) means for associating and storing the advertisement data of each advertisement and data which has been added to the advertisement data and is indicative of a viewing/listening period of the advertisement data, (2) means for determining a remaining viewing/listening period of the advertisement data of the advertisement, based on the viewing/listening period, and (3) means for determining the value of a coefficient representing a weight, wherein the weight becomes greater as the remaining viewing/listening period becomes shorter.

An advertisement data reproducing apparatus of the present invention is characterized in that, in the above advertisement data reproducing apparatus, the means of said item (A) comprises: (1) means for associating and storing, with the advertisement data, data which is indicative of first selected categories specifying audience groups which are targets of the advertisement, and data which is indicative of values of coefficients assigned to the respective first selected categories; wherein the associated and stored data has been added to the advertisement data; the first selected categories are selected from category data for specifying audience groups, and the category data comprises a plurality of items and each item comprises a plurality of categories to specify audience groups; and the values of the coefficients respectively represent weights of the first selected categories, and a greater weight is assigned to a first selected category having more importance, (2) means for storing data which is indicative of second selected categories which are selected from the category data for specifying audience groups, wherein the second selected categories specify audience groups to which the audience of the receiver belongs, and (3) means for determining the value of a coefficient representing a degree of coincidence between the categories targeted by the advertisement and the categories to which the audience belongs, based on the coefficient values assigned to the first selected categories which coincide with the second selected categories, wherein the degree of coincidence represents a weight which becomes greater as the degree of coincidence becomes higher.

An advertisement data reproducing apparatus of the present invention is characterized in that, in the above advertisement data reproducing apparatus, the means of said item (A) comprises: (1) means for associating and storing the advertisement data of each advertisement and data which has been added to the advertisement data and is indicative of the number of reproduction of the advertisement data, (2) means for determining a remaining number of reproductions of the advertisement data of the advertisement, based on the number of reproductions, and (3) means for determining a value of a coefficient representing a weight, wherein the weight becomes greater as the remaining number of reproduction becomes larger.

An advertisement data reproducing apparatus of the present invention is characterized in that, in the above advertisement data reproducing apparatus, the number of reproductions, which is associated with the advertisement data by the means of item (1) which associates the advertisement data and the data indicative of the number of reproductions, defines an upper limit of the number of reproductions of the advertisement on the receiver which stores the advertisement; and the number of reproductions is an averaged reproduction number which is assigned equally to each receiver which stores the advertisement.

An advertisement data reproducing apparatus of the present invention is characterized in that, in the above advertisement data reproducing apparatus, the number of reproductions, which is associated with the advertisement data by the means of item (1) which associates the advertisement data and the data indicative of the number of reproductions, defines an upper limit of the number of reproductions of the advertisement on the receiver which stores the advertisement; and the number of reproduction is a reproduction number which is individually assigned to each receiver which stores the advertisement and which is derived based on the degree of coincidence between an audience group targeted by the advertisement and an audience group to which the audience of the receiver belongs.

An advertisement data reproducing apparatus of the present invention is characterized in that, in the above advertisement data reproducing apparatus, the means of said item (A) comprises: (1) means for detecting, among the stored advertisement data of the respective advertisements, advertisement data which was reproduced, and (2) means for determining the value of a coefficient representing a weight of advertisement data of each stored advertisement, wherein the weight is determined to provide the detected advertisement data of the advertisement with a lower rank in a predetermined reproduction order of advertisements than the advertisement data of the advertisements which are waiting for reproduction.

An advertisement data reproducing apparatus of the present invention is characterized in that, in the above advertisement data reproducing apparatus, the means of said item (A) comprises: (1) means for associating and storing the advertisement data of each advertisement and time slot data and data indicative of a value of a coefficient assigned to the time slot data; wherein the time slot data is selected from preferential display time data which comprises time slot data for each of a plurality of time slots, for specifying one or more times of day when the advertisement is desired to be preferentially reproduced; and the value of the coefficient represents a weight of the selected time slot, and a greater weight is assigned to a selected time slot having a greater importance, (2) means for determining a time slot to which the present time of day belongs, (3) means for reading out, from the means of said item (1), the value of the coefficient assigned to the time slot data which corresponds to the time slot determined by the means of said item (2), and (4) means for determining a priority order for reproducing the stored advertisement data of respective advertisements on the receiver based on the value of the coefficient.

An advertisement data reproducing apparatus of the present invention is characterized in that, in the above advertisement data reproducing apparatus, the means of said item (A) comprises: (1) means for obtaining, for advertisement data of each advertisement, advertisement attribute data which represents a category to which an object to be advertised by the advertisement belongs, and adding the obtained advertisement attribute data to the advertisement data, (2) means for assigning the value of a coefficient, which represents importance of the category indicated by the advertisement attribute data, to the advertisement attribute data, (3) means for increasing or decreasing by the audience of the receiver the value of the coefficient assigned to the advertisement attribute data when needed, and (4) means for determining a priority order for reproducing the stored advertisement data of respective advertisements on the receiver based on the value of the coefficient.

An advertisement data reproducing apparatus of the present invention is characterized in that, in the above advertisement data reproducing apparatus, the means of said item (C) which determines a priority order of reproduction on the receiver comprises means for changing the value of the coefficient by applying thereto the value of a different coefficient.

An advertisement data reproducing apparatus of the present invention comprises, in an advertisement data reproducing apparatus wherein advertisement data for a plurality of advertisements is stored at an audience side and the stored advertisement data is reproduced on a receiver: (A) means for conducting, for the advertisement data of each advertisement, weighting regarding priority for reproducing the advertisement data, and determining the value of a coefficient representing the weight in such a manner that the weight becomes greater as the priority becomes higher, (B) means for associating and storing the advertisement data of each advertisement, the value of the coefficient corresponding to the advertisement data, and identification data for identifying the advertisement data, (c) means for determining a priority order of the advertisement data of the respective advertisements for reproducing the advertisement data on the receiver, based on the value of the coefficient, (D) means, in response to a command to instruct reproduction of the advertisement data, for reading out and reproducing the stored advertisement data of respective advertisements in accordance with the priority order, and (E) means, in response to the identification data of the advertisement data if it is included in the command to instruct reproduction of the advertisement data, for most-preferentially reproducing the advertisement data which is identified by the identification data among the stored advertisement data of advertisements.

A storage medium of the present invention is that which stores a computer program which enables a computer to operate a procedure for storing advertisement data of a plurality of advertisements at an audience side and reproducing the stored advertisement data on a receiver, and characterized in that the procedure comprises steps of: for the advertisement data of each advertisement, conducting weighting with respect to a priority for reproducing the advertisement data; based on the weight, determining a priority order of the advertisement data of the respective advertisements for reproducing the advertisement data on the receiver; and, in response to a command to instruct reproduction of reproduce the advertisement data, reproducing the stored advertisement data of respective advertisements in accordance with the priority order.

A storage medium of the present invention is characterized in that, in the above storage medium, the procedure comprises the steps of: (1) for the advertisement data of each advertisement, adding data indicative of a viewing/listening period for the advertisement data, (2) based on the viewing/listening period, determining a remaining viewing/listening period for the advertisement data of the advertisement, (3) for the remaining viewing/listening period, determining the value of a coefficient representing a weight, wherein the weight becomes greater as the remaining viewing/listening period becomes shorter, and (4) based on the value of the coefficient, determining a priority order for reproducing the stored advertisement data of respective advertisements on the receiver.

A storage medium of the present invention is characterized in that, in the above storage medium, the procedure comprises the steps of: (1) for each advertisement, selecting, from category data for specifying audience groups, categories which specify audience groups which are targets of the advertisement, wherein the category data for specifying audience groups comprises a plurality of items and each item comprises a plurality of categories of audience groups; assigning the value of a coefficient representing a weight to each of the selected categories, wherein a greater weight is assigned to a category having more importance; and adding, to the advertisement data of the advertisement, first data which represents the selected categories and data which represents the values of the coefficients assigned to each of the selected categories, (2) selecting, from the category data for specifying audience groups, categories which specify audience groups to which the audience of the receiver belongs; and storing, at the audience side, second data which represents the selected categories, (3) based on the assigned coefficient values of the selected categories among the first data which coincide with the selected categories represented by the second data, determining the value of a coefficient which represents the degree of coincidence between the categories targeted by the advertisement and the categories to which the audience belongs, and (4) based on the value of the coefficient representing the degree of coincidence, determining a priority order for reproducing the stored advertisement data of respective advertisements on the receiver.

A storage medium of the present invention is characterized in that, in the above storage medium, the procedure comprises the steps of: (1) for the advertisement data of each advertisement, adding data indicative of the number of reproductions of the advertisement data, (2) based on the number of reproductions, determining a remaining number of reproductions of the advertisement data of the advertisement, (3) for the remaining number of reproductions, determining the value of a coefficient representing a weight, wherein the weight becomes greater as the remaining number of reproduction becomes larger, and (4) based on the value of the coefficient, determining a priority order for reproducing the stored advertisement data of respective advertisements on the receiver.

A storage medium of the present invention is characterized in that, in the above storage medium, the number of reproductions in the step (1), which adds data indicative of the number of reproductions of the advertisement data, defines an upper limit of the number of reproductions of the advertisement on the receiver, and is an averaged reproduction number which is assigned equally to each receiver which stores the advertisement.

A storage medium of the present invention is characterized in that, in the above storage medium, the number of reproductions in the step (1), which adds data indicative of the number of reproductions of the advertisement data, defines an upper limit of the number of reproductions of the advertisement on the receiver, and is a reproduction number which is assigned individually to each receiver which stores the advertisement and which is derived based on a degree of coincidence between an audience group targeted by the advertisement and the audience group to which the audience of the receiver belongs.

A storage medium of the present invention is characterized in that, in the above storage medium, the procedure comprises the steps of: (1) among the stored advertisement data of the respective advertisements, detecting advertisement data which has been reproduced, (2) for advertisement data of each stored advertisement, determining the value of a coefficient representing a weight, wherein the weight is determined so as to provide the detected advertisement data of the advertisement with a lower rank in a predetermined reproduction order of advertisements than the advertisement data of each of advertisements which is waiting for reproduction, and (3) based on the value of the coefficient, determining a priority order for reproducing the stored advertisement data of respective advertisements.

A storage medium of the present invention is characterized in that, in the above storage medium, the procedure comprises the steps of: (1) for advertisement data of each advertisement, selecting time slot data from preferential display time data which comprises time slot data for each of a plurality of time slots, for specifying one or more time of day at which the advertisement is desired to be preferentially reproduced; assigning the value of a coefficient representing a weight to the selected time slot data, wherein a greater weight is assigned to a selected time slot having more importance; and adding, to the advertisement data of the advertisement, the selected time slot data and data which represents the value of the coefficient assigned to the time slot data, (2) determining a time slot to which the present time of day belongs, (3) reading out the value of the coefficient assigned to the time slot data which corresponds to the time slot determined in the step (2), and (4) based on the value of the coefficient, determining a priority order for reproducing the stored advertisement data of respective advertisements on the receiver.

A storage medium of the present invention is characterized in that, in the above storage medium, the procedure comprises the steps of: (1) for advertisement data of each advertisement, selecting advertisement attribute data representative of a category to which an object to be advertised by the advertisement belongs; and adding the selected advertisement attribute data to the advertisement data, (2) for the advertisement attribute data, assigning the value of a coefficient which represents importance of the category represented by the advertisement attribute data, (3) if needed, increasing or decreasing the value of the coefficient assigned to the advertisement attribute data by the audience of the receiver, and (4) based on the value of the coefficient, determining a priority order for reproducing the stored advertisement data of respective advertisements on the receiver.

A storage medium of the present invention is characterized in that, in the above storage medium, the step of determining a priority order for reproducing the stored advertisement data of respective advertisements on the receiver comprises a step of changing the value of the coefficient by applying thereto the value of a different coefficient.

A storage medium of the present invention is that which stores a computer program which enables a computer to operate a procedure for storing advertisement data of a plurality of advertisements at an audience side and reproducing the stored advertisement data on a receiver, and characterized in that the procedure comprises steps of: for the advertisement data of each advertisement, adding identification data to identify the advertisement data; conducting weighting with respect to a priority for reproducing the advertisement data; based on the weight, determining a priority order of the advertisement data for the respective advertisements for reproducing the advertisement data on the receiver; and, in response to a command to instruct reproduction of the advertisement data, reproducing the stored advertisement data of respective advertisements in accordance with the priority order; wherein if the identification data is included in the command to instruct reproduction of the advertisement data, in response thereto, the advertisement data which is identified by the identification data among the stored advertisement data of advertisements is most-preferentially reproduced.

### BRIEF DESCRIPTION OF THE DRAWINGS

FIG. 1 is a table showing a concept of a method for determining a priority order of display of advertisements of the present invention.

FIG. 2 illustrates a construction of an apparatus on a transmitting side in an advertisement display controlling system of the present invention.

FIG. 3 illustrates a construction of an apparatus on a receiving side in the advertisement display controlling system of the present invention.

FIG. 4 is a flow chart showing preparation steps on the receiving side.

FIG. 5 is a flow chart showing a step, on a broadcasting side, for analyzing audience data.

FIG. 6 is a flow chart showing steps, on the broadcasting side, for preparing and transmitting advertisement data.

FIG. 7 is a flow chart showing steps, on the receiving side, for receiving, selecting and storing advertisement data.

FIG. 8 is a flow chart showing steps, on the transmitting side, for preparing an advertisement command signal.

FIG. 9 is a flow chart showing steps, on the receiving side, for determining a priority order of stored advertisement data and displaying an advertisement.

FIG. 10 is a flow chart continuing from FIG. 9 and indicates the steps for determining a priority order of the stored advertisement data and displaying an advertisement on the receiving side.

FIG. 11 is a flow chart continuing from FIG. 10 and indicates the steps for determining a priority order of the stored advertisement data and displaying an advertisement on the receiving side.

FIG. 12 is a flow chart continuing from FIG. 11 and indicates the steps for determining a priority order of the stored advertisement data and displaying an advertisement on the receiving side.

FIG. 13 is a flow chart continuing from FIG. 12 and indicates the steps for determining a priority order of the stored advertisement data and displaying an advertisement on the receiving side.

FIG. 14 is a flow chart showing steps, on the receiving side, for storing history data concerning advertisement displays.

FIG. 15 is a flow chart showing steps, on the transmitting side, for processing and controlling history data that is fed back from the receiving side.

FIG. 16 is a flow chart showing steps, on the transmitting side, for generating statistical data based on the history data that is fed back from the receiving side.

FIG. 17 is a flow chart showing steps, on a transmitting side, for preparing and transmitting advertisement data in a second embodiment.

### DETAILED DESCRIPTION OF THE PREFERRED EMBODIMENT

Embodiments of the present invention will be hereinafter described.

First, a basic concept of the present invention will be described. The present invention causes a receiver to store advertisements desired by an audience in advance and to display the stored plurality of advertisements, by sending commands from a transmitting side (host side), in accordance with a priority order based on necessary elements determined by a sponsor, thereby realizing improvement of advertisement effects.

The elements for determining a priority order of stored advertisements are, for example, (1) a viewing/listening period (display period) of each advertisement stored on each receiver, (2) the ordered number of reproducing of each advertisement (the number of displaying), that is, the total number of reproductions in all receivers (the total number of displaying), (3) a degree of coincidence between an audience group targeted by each advertisement and an audience group to which the audience of each receiver belongs, (4) preferred display time designated by a sponsor, (5) a predetermined reproduction order (predetermined display order) to be assigned to each advertisement stored on each receiver, (6) the number of displays required by each receiver in order to attain the total number of displays of each advertisement, and (7) an attribute of the advertisement, that is, a degree of preference of an audience of a receiver with respect to a category to which each advertisement belongs. Each of these elements is converted into a value representing a weight, and a high priority order is given to an advertisement with a large sum of weight values. Moreover, as an element for determining a priority order of stored advertisements, there is (8) an interrupt command (advertisement designation command) for displaying an advertisement of a specific ID.

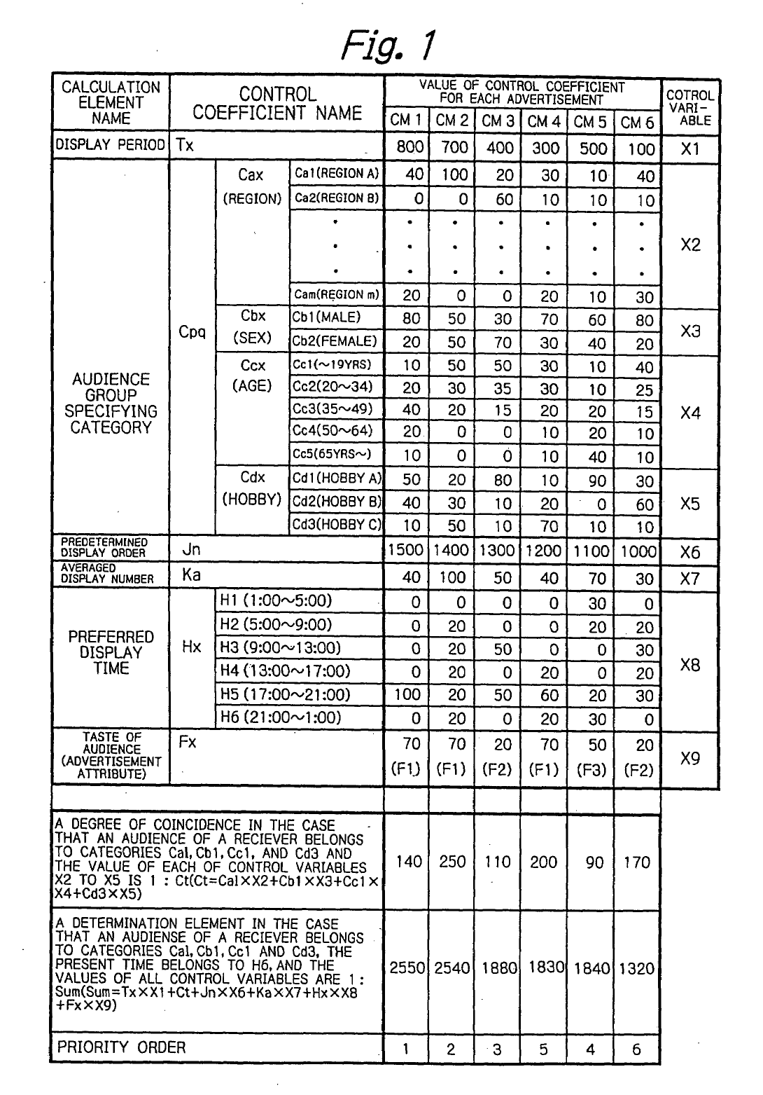

FIG. 1 shows a table for showing a concept of a method for determining a priority order of displaying of advertisements of the present invention.

A table in the upper part of FIG. 1 indicates names of calculation elements for determining a priority order of displaying each of advertisements CM1, CM2, CM3, CM4, CM5 and CM6, names of control coefficients for the calculation elements, values of the control coefficients applied to each advertisement, and control variables applied to the control coefficients. A table in the lower part of FIG. 1 relates to the table in the upper part, and indicates, for each advertisement, a coincidence degree value indicating a degree of matching (coincidence) between an audience and the advertisement, values of determination elements of a priority order with respect to each advertisement, and a priority order.

The calculation elements include a display period, an audience group specifying category, a predetermined display order, the averaged display number, a preferred display time, and the taste of an audience (advertisement attributes).

The display period of the calculation elements is an element corresponding to a viewing/listening period of above item (1). The display period element is a weighted value that is calculated based on the display period of each advertisement stored on each receiver, and is represented by a control coefficient Tx. The control coefficient Tx changes as time passes, and the shorter the remaining display period the larger the value becomes.

The audience group specifying category of the calculation element is an element which is a basis for determining the degree of coincidence of above item (3), and is data that is inputted when the advertisement is ordered, in order for a sponsor to specify an audience group that is to be a target of an advertisement. Information for specifying an audience group is classified into a plurality of main items such as region, sex, age and the like, and each item is sub-classified into a plurality of categories. For example, if an item, that is, a main classification is “sex,” information is sub-classified into the category of “male” and the category of “female.” A sponsor assigns a value representing a weight to each category of the audience group specifying category, in order to specify an audience group to be a target of an advertisement. A weighted value is represented by a control coefficient Cpq, and a larger value is assigned to a category which is regarded to be more important. The value assigned by the sponsor is a fixed value, and does not change. On the receiver, this weighted value is reflected only on a category to which the audience belongs.

The predetermined display order of the calculation element is an element corresponding to the predetermined display order of above item (5). The predetermined display order element is a weighted value that is calculated based on a predetermined order of display assigned to each advertisement stored on each receiver, and is represented by a control coefficient Jn. The control coefficient Jn is changed when an advertisement is displayed. The higher the predetermined display order the larger the control coefficient Jn becomes in value.

The averaged display number of the calculation element is an element corresponding to the number of displays of above item (6). The averaged display number element is a weighted value that is calculated based on the remaining number of displays until the averaged display number is reached, and is represented by a control coefficient Ka (Ka is a value obtained by applying a coefficient to the remaining number of display). The value of the averaged display number is obtained by multiplying a value (the averaged minimum display number), which is obtained by dividing the ordered total number of displays of each advertisement by the number of all receivers, by a coefficient. The value of the averaged display number (initial value) obtained for each advertisement is the same for all the receivers storing the advertisement. The remaining number of displays is obtained by subtracting one from the averaged display number each time an advertisement is displayed. The control coefficient Ka becomes zero when the remaining number of display becomes zero. An advertisement with the control coefficient Ka reaching zero is no longer displayed.

A coincidence degree value (Ct) indicates a degree of coincidence between an audience group targeted by an advertisement and an audience group to which the audience belongs. On the receiving side, the audience selects a category indicating an audience group to which the audience belongs out of the audience group specifying category data, and stores it as personal data. The total of the control coefficients Cpq assigned by each sponsor with respect to the categories indicated in the personal data becomes a value indicating the degree of coincidence of above item (3). The initial value of the control coefficient Ct is a constant value for each advertisement material, and is changed only by a control variable application command. For example, in the case in which the control coefficient Cpq (Cax, Cbx, Ccx, and Cdx) is multiplied by a control variable Xn (X2 to X5), since the value of the control coefficient Cpq changes if the control variable Xn is a value other than one, the coincidence degree value Ct also changes. The higher the degree of coincidence the larger the control coefficient Cpq becomes.

The preferred display time of the calculation element is an element corresponding to the preferred display time of above item (4). A value of the preferred display time element, that is, a preferred display time value (Hx) is an element with the purpose that an advertisement is preferentially displayed during a time slot designated by a sponsor. All receivers become targets of preferred display, and a numerical value to be reflected changes according to a time slot during which an advertisement is displayed. That is, if the present time and the designated time slot coincide with each other, a value assigned for the time slot is made effective.

The tastes of an audience of the calculation element is an element corresponding to the preference of an audience of above item (7). An advertisement attribute (Fx) indicates to which category an advertisement belongs. The advertisement attribute is classified into categories such as cars, foods, electric appliances, etc., and is represented by adding a weight to each of them. Initially assigned numerical values of the Fx's (F1 to Fn) are equivalent for all advertisements, but the value for each category increases or decreases every time a voting input regarding preference/non-preference is inputted by an inputting device (inputting system) of a receiver. That is, for example, if a preferred advertisement is an advertisement for a car, the values assigned to all the categories specifying the attribute “car” equally increase and, consequently, the priority of the advertisements become higher than advertisements belonging to other categories. In this case, advertisements belonging to the category of cars tend to be more preferentially displayed. In addition, if the advertisement is not preferred, the priority becomes lower, and the advertisement tends to be displayed less.

The control variable Xn (X1 to X9 in FIG. 1) applied by the control variable application command determines the importance of each control coefficient (Tx, Cpq, Jn, Ka, Hx and Fx), and it is the coefficient which is determined on the transmitting side (host side) in order to determine which coefficient should be prioritized based on feedback of a history (a history of display states of an advertisement or the like), business information or the like. By multiplying Xn (X1 to X9) to coefficients Tx, Cpq, Jn, Ka, Hx and Fx, respectively, it is possible to define a coefficient(s) which is regarded to be important. A command for application of the control coefficient is given in a step before finally summing up all the control coefficients, that is, before calculating a determination element (Sum) that will be hereinafter described. For example, when a deadline for a display approaches, multiply the values for the number and(or) the period, that is, the control coefficients Tx and(or) Ka by a large value, and multiply the other control coefficients by small values, thereby making it possible to increase priorities of the number and the period.

The determination element (Sum) indicates the sum of the values of the control coefficients Tx, Jn, Ka, Hx and Fx to which the control variable Xn is applied and the value of Ct (i.e., a sum of the values of Tx′, Jn′, Ka′, Hx′, Fx′, Cax′, Cbx′, Ccx′ and Cdx′). This value of the sum is a value comprehensively indicating the weight of each advertisement, and a final priority order is determined based on this value. The control coefficient Tx is a variable that varies depending on time, the control coefficients Ka and Jn are variables that vary depending on display of an advertisement, the control coefficient Hx is a variable that varies depending on the time of day, and the control coefficient Fx is a variable that varies according to the voting of an audience. Moreover, since the control variable (Xn) is applied to each of the control coefficients, values of the control coefficients vary depending on values of the control variables. Therefore, the value of the sum (Sum) of the control coefficient also varies depending on time, display of an advertisement, time of day, the voting of an audience, and the control variables.

A priority order (N) indicates the ranks of higher to lower places assigned to advertisements in the order of a larger value of the determination element (Sum), and is a final priority order. A receiver displays stored advertisements in accordance with this priority order.

An embodiment of the present invention will now be described with reference to the drawings.

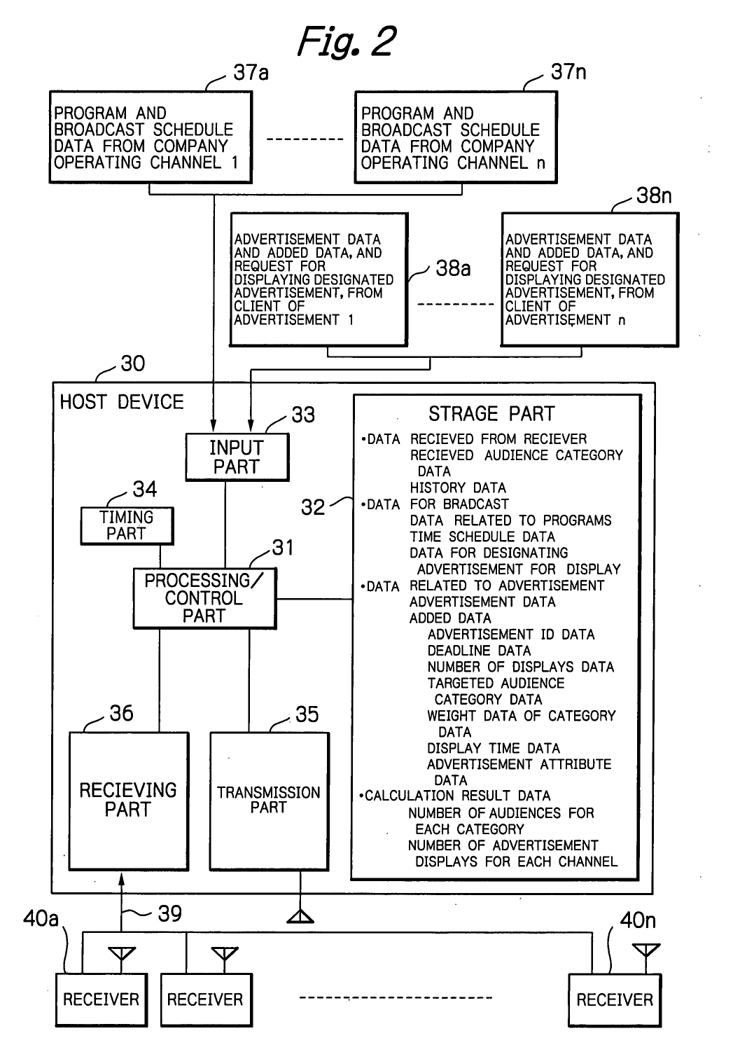

FIG. 2 illustrates the configuration of an apparatus on the transmitting side in the advertisement display controlling system of the present invention. The apparatus on the transmitting side is provided with a processing/control part 31. The processing/control part 31 performs processing for overall control of a host device 30, management, constructing, editing and transmission/reception of advertisement data and additional data, management of personal data of the audience of each receiver, management of history data concerning a display states of each advertisement collected from each receiver, constructing and management of a control command to be transmitted to a receiver, constructing and management of various kinds of data for calculation, constructing and management of data for accounting, and the like. A storage part 32, an input part 33, a timing part 34, a transmission part 35 and receiving part 36 are connected to the processing/control part 31.

The input part 33 receives program(show) data and broadcast schedule data 37 (37a to 37n) from the broadcasting company for each channel, and also receives advertisement data and additional data 38 (38a to 38n) relating to the advertisement from a client of each advertisement or an advertisement agency, stores the received data in the storage part 32, processes the stored data in the processing/control part 31, and transmits the data to a receiver 40 (40a to 40n) via the transmission part 35.

In addition, the receiving part 36 receives history data accumulated on the receiver 40, processes the data in the processing/control part 31, and stores the data in the storage part 32.

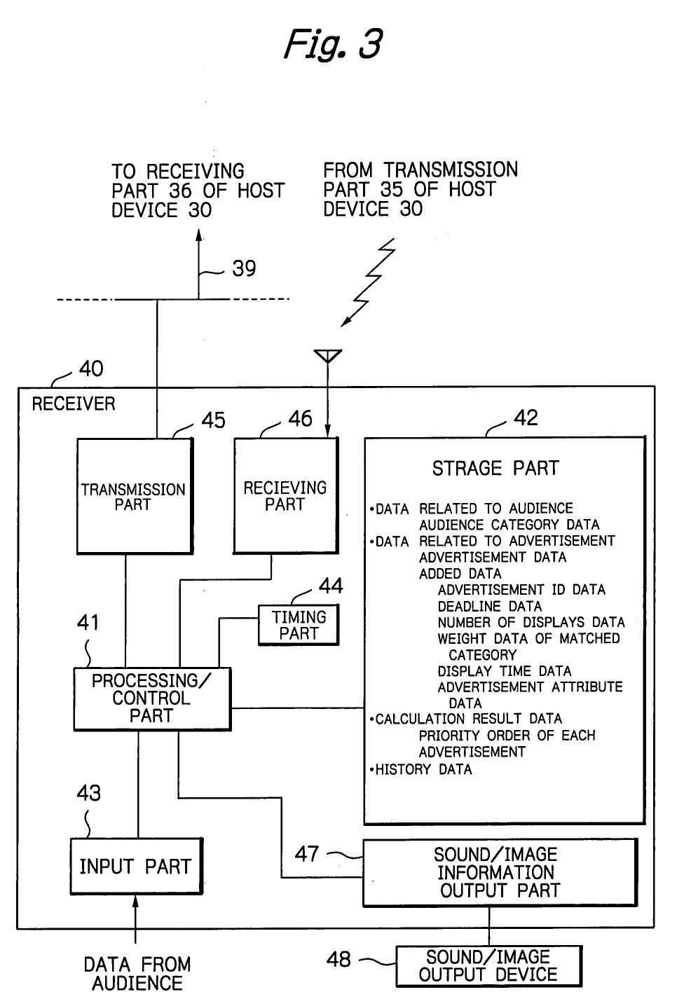

FIG. 3 illustrates a configuration of an apparatus on the receiving side in the advertisement display controlling system of the present invention. The main part of the apparatus on the receiving side is the receiver 40.

The receiver 40 is provided with a processing/control part 41. A storage part 42, an input part 43, a timing part 44, a transmission part 45, a receiving part 46 and a sound/image information output part 47 are connected to the processing/control part 41.

The processing/control part 41 performs processing for overall control of the receiver 40, control of display of an advertisement, control of management of history data concerning display states of each advertisement, and the like.

The receiver 40 receives program(show) data, and advertisement data and additional data 38 relating to the advertisement, processes the received data in the processing/control part 41, and outputs the processed data to a sound/image output device 48 via the sound/image information output part 47. In addition, the receiver 40 is a receiving device for communicating with and receiving arbitrary wire and wireless broadcasts and telecommunications such as a CS, BS, terrestrial TV, cable, etc.

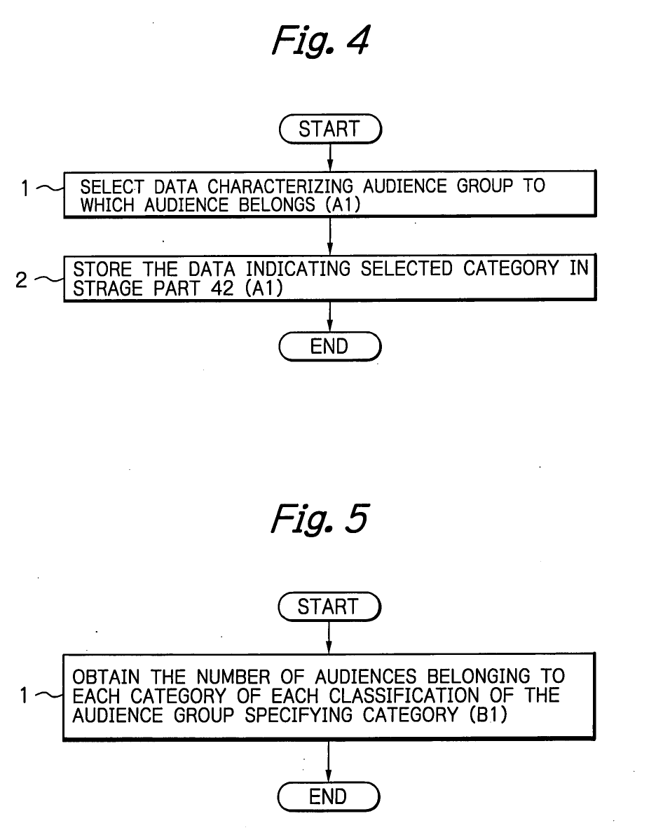

A first exemplified embodiment of operations of an advertisement display controlling system will now be described with reference to FIGS. 4 to 16. In this embodiment, the display period (control coefficient Tx), the audience groups specifying category (control coefficient Cpq), the predetermined display order (control coefficient Jn), the average number of display (control coefficient Ka), the preferred display time (control coefficient Hx) and the tastes of the audience (advertisement attribute) (Fx), which are shown in FIG. 1, are used as calculation elements of a priority order of advertisements.

FIG. 4 shows preparation steps on the receiving side, that is, the receiver 40.

A. Preparation step on the receiving side:

A1. In step 1, the audience of the receiver 40 selects data characterizing an audience group to which the audience belongs out of, for example, a plurality of categories indicated in audience group specifying category data described in a questionnaire sheet, a mark sheet or the like that are prepared on the transmitting side (a company operating a broadcasting business using the host device 30, etc.) and supplied to the audience. In step 2, the audience stores the data indicating the selected categories in the storage part 42 via the input part 43 and the processing/control part 41.

In addition, the system may be configured such that, on the receiver 40, an inputting device such as a GUI and a keyboard, etc., is provided with the input part 43, software for selecting a category from the audience group specifying category data is loaded in the storage part 42, and the audience group specifying category data is displayed on the sound/image output device 48, whereby a category is selected and inputted using the above input device.

The audience groups specifying category data is classified into a plurality of main items, and each item is sub-classified into a plurality of categories. This sub-classification is hereinafter referred to as a category. Referring to the example of FIG. 1, the audience group specifying category data is classified into four main classifications (items) of region (Cax), sex (cbx), age (Ccx) and hobby (Cdx). Moreover, the classification Cax is sub-classified into m categories of region A (Ca1) to region m (Cam); the classification Cbx is sub-classified into two categories of male (Cb1) and female (Cb2); the classification Ccx is sub-classified into five categories of 19 years old or under (Cc1) to 65 years old or over (Cc5); and the classification Cdx is sub-classified into three categories of hobby A (Cd1) to hobby C (Cd3). In this embodiment, for example, if the audience of the receiver 40 lives in the region A, is a male, 19 years old or under, and has the hobby C, the audience selects the categories Ca1, Cb1, Cc1 and Cd3, inputs the data from the input part 43 as personal data, and stores the data in the storage part 42.

In addition, data indicating a channel number (the name of a broadcasting company) of a pay broadcast that the audience subscribes to, and other data (e.g., data indicating a telephone number, a credit card number, the name of a place of employment. etc.) may be further included in the personal data.

Also, although it is optional, by registering the personal data in the storage part 32 of the host device 30, it becomes possible to produce various kinds of audience data. The method of communicating the personal data to the host device 40 is arbitrary, and which includes, for example, a method of directly transmitting from the transmission part 45 of the receiver 40 to the receiving part 36 of the host device 30 through a line 39 such as a telephone line, a method of writing on paper and transmitting by facsimile, mail or the like, a method of recording in a recording medium such as a magnetic disk or an optical disk and transmitting by mail or the like, and a method of orally communicating through a telephone or the like.

In addition, for example, in the case in which a plurality of audiences with members in different age groups, sexes, hobbies, etc., (for example, a family) use one receiver or the case in which one audience has a plurality of hobbies, it is necessary to designate a plurality of categories in each main classification in order to reflect all the characteristics. Therefore, the system can be configured such that the audience of the receiver 40 can select a plurality of categories in one classification, and a plurality of audiences can be separately registered on the receiver in advance. If a plurality of audiences are separately registered on the receiver in advance, for example, selection buttons for identifying each audience are provided with the receiver, and each audience presses a selection button for identifying the audience when the audience uses the receiver (views and listens to a program).

The storage part 42 of the receiver 40 stores a computer program for performing the above steps.

FIG. 5 shows a step for analyzing audience data on the broadcasting side, that is, the host device 30.

B. Audience data analyzing step on the broadcasting side:

B1. In step 1, the host device 30 obtains the number of audiences (Sa1 to Sd3) belonging to each category (Ca1 to Cd3) of each classification of the audience group specifying category, with respect to residents in an area in which a broadcast can be received. The method of obtaining the number of audiences is arbitrary. For example, if personal data transmitted from the transmission part 45 of the receiver 40 is received by the receiving part 36 and stored in the storage part 32, the number of audiences for each category can be calculated by the processing/control part 31 based on the data. If data is obtained by a market research or the like concerning the residents, the number of audiences for each category which is obtained based on the data is stored in the storage part 32 from the input part 33 through the processing/control part 31.

In this example, reference symbol Sa1 denotes the number of audiences belonging to the category Ca1 and reference symbol Sa2 denotes the number of audiences belonging to the category Ca2. Similarly, in the description below, among reference symbols representing categories and reference symbols representing the numbers of audiences, reference symbols having two characters on the right side in common are related.

The number of audiences to be targets of an advertisement, that is, the size of the market can be seen from the number of audiences belonging to each category. The size of a market can be used as a standard in determining an outline of the number or the period of displaying an advertisement. In addition, it becomes possible to estimate an effect of the advertisement, that is, the number of audiences who watch the advertisement; and the data can be utilized when selling an advertisement frame. In addition, the number of receivers may be counted instead of the number of audiences belonging to each category.

The method for obtaining personal data to be used for calculating the number of audiences (the number of receivers) belonging to each category is arbitrary. For example, if a large number of pieces of personal data are registered in the host device 30 in the above step A1, it is possible to use the same.

As another method of obtaining personal data, for example, market research (a questionnaire or the like taken by paper, orally, etc.) is performed in one region where advertisement data can be received; personal data of residents is obtained; and the number of residents belonging to each category of the audience group specifying category is aggregated. The personal data of residents may be obtained by selecting residents at random by using a method such as a spot check, rather than selecting all the residents. The number of residents belonging to each category among all the residents can be approximately calculated by calculating a percentage of the number of residents belonging to each category from the personal data obtained from randomly selected residents and multiplying the percentage to the total number of residents. Moreover, as one method of calculating the number of receivers held by audiences belonging to each category, for example, it is advisable to multiply the total number of residents by the prevalence of the receiver.

For example, in the case in which an advertisement A targets an audience belonging to a category Cx2 of a classification Cxx of the audience group specifying category data, the total number of residents in an area where a broadcast can be received is 10,000, the prevalence of the receiver with respect to the number of residents is 90 percent, and 5 percent of the residents belong to the category Cx2, the number of receivers in which the advertisement A is stored can be calculated as 450 (=10,000×0.9×0.05).

Moreover, the number of audiences belonging to each category is checked for each channel (Ch1 to Chn), that is, it is checked how many audiences belong to which category of which classification of which channel. For example, data are obtained such as how many audiences belong to the categories Ca1, Ca2, Ca3, . . . , Cd2 and Cd3 of the classification Cax of the channel 1, how many audiences belong to the categories Ca1, . . . of the classification Cax of the channel 2, and how many audiences belong to the categories Ca1, . . . of the classification Cax of the channel 3 and so on, whereby more detailed data can be prepared. For example, such data can be approximately calculated by obtaining the number of audiences belonging to each category among all the audiences and a rating of each channel, and multiplying them together.

If personal data (including data indicating an audience group to which each audience belongs, data indicating a channel number such as that for a pay broadcast that each audience subscribes, and other data) can be obtained from many audiences of many receivers, more detailed data can be prepared in the host device 30.

The data, which is stored in the storage part 32 and indicates the number of audiences (receivers) belonging to each category, is used in calculating the upper limit display number (control coefficient Ku) of the second embodiment to be described later.

The storage part 32 of the host device 30 stores a computer program for performing the above step.

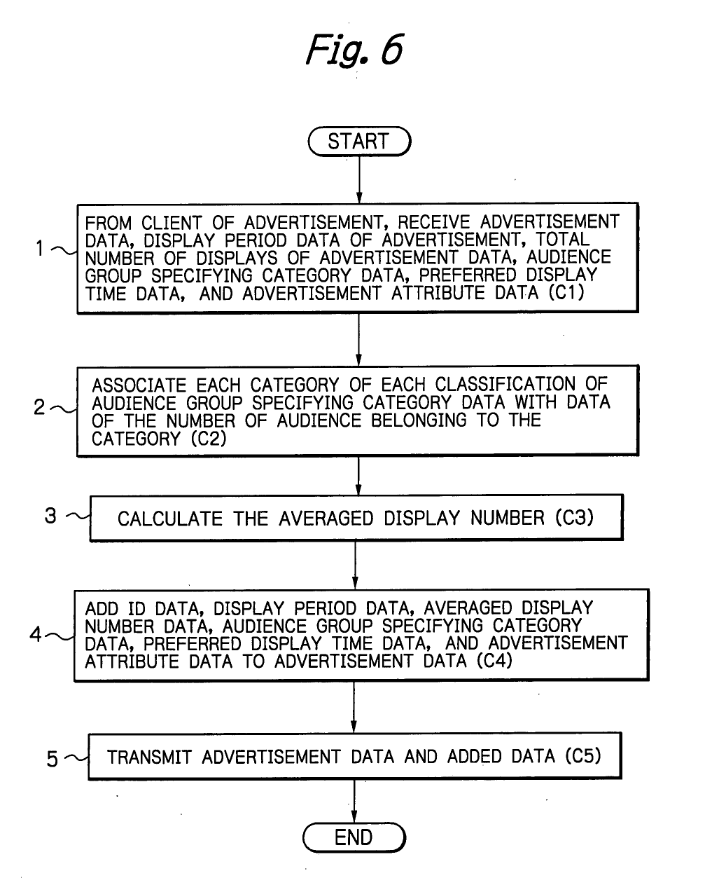

FIG. 6 indicates steps for preparing and transmitting advertisement data on the broadcasting side, that is, the host device 30.

C. Advertisement data preparing and transmitting steps on the broadcasting side:

C1. In step 1, the host device 30 receives, from a client of an advertisement, advertisement data, display period data of the advertisement, data indicating the total number of display of the advertisement, data for characterizing an audience group targeted by the advertisement (audience group specifying category data), data indicating a time slot in which the advertisement is desired to be displayed (preferred display time data), and data indicating a field of the advertisement (advertisement attribute data), inputs the data from the input part 33, and stores the data in the storage part 32 via the processing/control part.

The advertisement data is data representing images and sounds of an advertisement. The display period data is data representing, for example, a final date of display, the number of days to display an advertisement, etc. The data indicating the total number of display of the advertisement is data indicating the ordered number of display. The audience group specifying category data is data specifying audience groups targeted by the advertisement (the audience group specifying category of FIG. 1). The preferred display time data is data indicating a time slot (time of day) in which the advertisement is preferred to be preferentially displayed. The advertisement attribute data is data indicating a field (an advertisement attribute) to which goods to be publicized by the advertisement belongs. The advertisement attribute is classified as, for example, cars, insurance, foods or the like.

A sponsor assigns in advance a value representing a weight to each category of each classification of the audience group specifying category data, in order to specify an audience group targeted by an advertisement.

The sponsor selects a category indicating an audience group targeted by an advertisement out of a plurality of categories indicated in the audience group specifying category data which is described in a sheet such as a questionnaire sheet and a mark sheet that is prepared on the transmitting side (company operating a broadcasting business using the host device 30, or the like) and supplied to the sponsor, and enters the category into the sheet. The sponsor then determines and enters a value indicating how much an audience belonging to the selected category is regarded to be important (a value indicating importance). Then, the data which indicates the category indicating the audience group targeted by the advertisement, and the data which indicates the value indicating the degree of importance assigned to the category, which was entered in the above sheet, is associated with the advertisement data and stored in the storage part 32 from the input part 33 of the host device 30 via the processing/control part 31.

In addition, the host device 30 may be configured such that an input device such as a GUI and a keyboard is provided with the input part 33, software for selecting categories from the audience group specifying category data and assigning values indicating importance of the selected categories is loaded in the storage part 32, the audience group specifying category data is displayed on the host device 30, and categories are selected and values for the selected categories are determined and inputted by using the above input device.

In the example of FIG. 1, the audience group specifying category data is classified into four main classifications of Cax, Cbx, Ccx and Cdx, and each classification is sub-classified into a plurality of categories (Ca1 to Cam, Cb1 to Cb2, Cc1 to Cc5, Cd1 to Cd3).

A sponsor assigns a large value to a category to which the sponsor attaches importance. In addition, the sponsor distributes numerical values such that the total of values to be assigned to the categories in one classification is 100. For example, in the classification Cbx (sex) of the advertisement CM1, 80 is assigned to the category Cb1 (male) and 20 is assigned to the category Cb2 (female), and the total of these values is 100. This indicates that CM1 targets both male and female, but male is regarded to be more important than female with the ratio of 80 to 20. Also, for example, in the classification Cdx of CM5, 90 is assigned to the category Cd1, 0 is assigned to the category Cd2, and 10 is assigned to the category Cd3. This indicates that an audience group belonging to the category Cd1, an audience group belonging to the category Cd2 and an audience group belonging to the category Cd3 are attached importance at the ratio of 90 to 0 to 10. Further, the value of 0 means that the audience group is not considered as a target at all.

In addition, the sponsor assigns a value representing a weight to each time slot of the preferred display time data in order to specify a time slot(s) in which the sponsor wishes to display an advertisement.

The sponsor selects a time slot (one or a plurality of time slots) in which the sponsor wishes to display an advertisement preferentially out of a plurality of time slots indicated in the preferred display time data described on the above sheet such as a questionnaire sheet and a mark sheet, and determines and enters a value indicating the degree of importance the sponsor attaches to the time slot (a value indicating importance). The sponsor then associates the preferred display time data, which indicates the selected time slot(s) and the assigned value indicating the importance of the time slot, with the advertisement data, and stores the data in the storage part 32 from the input part 33 of the host device 30 via the processing/control part 31.

Also, the host device 30 may be configured such that an inputting device such as a GUI and a keyboard is provided with the input part 33, software for selecting a time slot out of the preferred display time data and assigning a value indicating importance is loaded in the storage part 32, the preferred display time data is displayed on the host device 30, and a time slot(s) is selected and a value(s) for the selected time slot(s) is determined and inputted by using the above input device.

In the example of FIG. 1, the preferred display time data is classified into six time slots of H1 (1 o'clock to 5 o'clock), H2 (5 o'clock to 9 o'clock), H3 (9 o'clock to 13 o'clock), H4 (13 o'clock to 17 o'clock), H5 (17 o'clock to 21 o'clock) and H6 (21 o'clock to 1 o'clock). A sponsor assigns a larger value to a time slot in which the sponsor wishes to display an advertisement, that is, a time slot to which the sponsor attaches importance. In addition, the sponsor distributes numerical values such that the total of values assigned to all the time slots is 100. For example, in the advertisement CM4, 0 is assigned to the time slots H1, H2 and H3, 20 is assigned to H4, 60 is assigned to H5, and 20 is assigned to H6, and the total of these values is 100. This indicates that the sponsor attaches importance to the time slots of H1, H2, H3, H4, H5 and H6 at the ratio of 0 to 0 to 0 to 20 to 60 to 20, and wishes that the advertisement is displayed preferentially in the time slots of H4, H5 and H6 (especially in the time slot of H5). Further, the value of 0 means that the sponsor does not wish the advertisement to be displayed in the time slot.

Moreover, the sponsor designates an advertisement attribute in order to specify a field to which the good to be publicized by the advertisement (attribute) belongs. The advertisement attribute includes, for example, car, food, electric appliance, and so on. As described above, an advertisement attribute that coincides with an attribute of the advertisement is selected out of advertisement attribute data described in a sheet such as a questionnaire sheet and a mark sheet, the advertisement attribute data indicating the advertisement attribute is associated with the advertisement data, and the data is stored in the storage part 32 from the input part 33 of the host device 30 via the processing/control part 31. Also, the host device 30 may be configured such that an inputting device such as a GUI and a keyboard is provided with the input part 33, software for selecting an advertisement is loaded in the storage part 32, the advertisement attribute data is displayed on the host device 30, and an advertisement attribute is selected and inputted using the above input device.

In the example of FIG. 1, an advertisement attribute is indicated in the column of the calculation element name “taste of an audience (advertisement attribute).” The advertisement attribute of the advertisements CM1, CM2, CM4 is F1, the advertisement attribute of CM3 and CM6 is F2, and the advertisement attribute of CM 5 is F3. The symbols F1 to F3 shown here indicate advertisement attributes, that is, fields to which advertisements (goods publicized by advertisements) belong.

C2. In step 2, the processing/control part 31 associates each category (Ca1 to Cd3 of FIG. 1) of each classification of the audience group specifying category data stored in the storage part 32 with data of the number of audience belonging to the category (Sa1 to Sd3). (Sa1 to Sd3 are used in a step for calculating the upper limit display number that will be described in the description of the operation of the second embodiment of the advertisement display controlling system.)

C3. In step 3, the processing/control part 31 calculates the averaged display number for each stored advertisement. The averaged display number is obtained by dividing the ordered total number of display of an advertisement by the number of all receivers to find the display number which is the average and is the required minimum display number for each of all the receivers (the averaged minimum display number), and multiplying the averaged minimum display number by a coefficient.

However, as described above, some of all the receivers may not store the advertisement or, even if they store the advertisement, some of them may not be able to complete the averaged minimum display number within a predetermined period. Therefore, it is difficult to attain the ordered total number of display of an advertisement if the averaged minimum display number calculated for the advertisement is assigned to a receiver storing the advertisement. Therefore, by multiplying the averaged minimum display number by a coefficient, the display number (averaged display number), which gives each receiver storing the advertisement scope for offsetting (mutually supplementing) a shortage of the number of displaying the advertisement, defines an upper limit of the display number for avoiding the advertisement to be displayed on each receiver too many times, and is assigned equally, is determined.

The value of the coefficient multiplying the averaged minimum display number becomes small, for example, if it is determined that the advertisements is aimed at an audience group including the large number of people, that is, the number of receivers storing the advertisement is large. To the contrary, the value becomes large if it is determined that the advertisements is aimed for an audience group including the small number of people, that is, the number of receivers storing the advertisement is small. The value of the coefficient can be experientially determined from, for example, data of display results of advertisements in the past, data concerning the number of people of an audience group or the like obtained by a questionnaire or the like described in the above item A, and data concerning an audience group that is targeted by an advertisement and is designated by the sponsor.

For example, it is assumed that the ordered total number of display is 10,000 for an advertisement belonging to a certain field, and the number of all receivers is 500. In addition, it is assumed that a percentage of receivers in which an advertisement belonging to a field is stored is statistically known to be 50 percent from data in the past or the like. In such a case, the averaged minimum display number for each receiver among all the receivers is 20 (10,000/500). This averaged minimum display number (20) is divided by the percentage of receivers in which the advertisement belonging to the field is stored (50 percent, i.e., 0.5). ((10,000/500)/0.5=40). That is, the percentage of receivers in which the advertisement belonging to the field is stored is applied to the averaged minimum display number as a coefficient. In this way, the number of displays of the advertisement that is at least required on each receiver storing the advertisement is approximately calculated. By further applying a coefficient to give scope to this value of the number of displays, the averaged display number is determined.

C4. In step 4, the processing/control part 31 adds ID data, display period data, audience group specifying category data (Ca1 to Cd3), preferred display time data (Hx), advertisement attribute data (F1 to F3) and averaged display number data to the advertisement data stored in the storage part 32, and prepares data for transmission to the receiver 40. ID data of an advertisement is data indicating an identification number of the advertisement, and is assigned when an order for an advertisement is received or when advertisement data is stored.

Steps similar to C1 to C4 are applied to other advertisements, and the advertisement data is associated with the additional data.

C5. In step 5, the processing/control part 31 makes one package by combining a plurality of pairs of the advertisement data and the additional data, and transmits the package from the transmission part 35 to the receiver 40 on occasion or periodically. A package may include only one pair of the advertisement data and the additional data. Although the advertisement data and the additional data may be transmitted by any wired system or wireless system, the data is transmitted by a wireless system in this example. (In the case of the first embodiment, since data of the number of audiences Sa1 to Sd3 is not used on the receiver 40, the data of the number of audiences may not be included in the additional data to be transmitted.)

Steps similar to the above items C1 to C5 (steps 1 to 5) are applied to an advertisement whose order is received anew.

The storage part 32 of the host device 30 stores a computer program for performing the above steps.

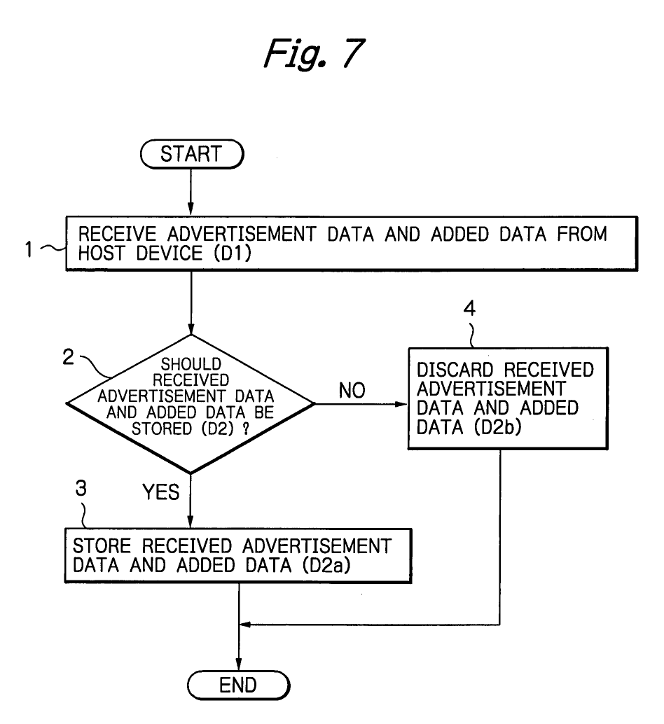

FIG. 7 describes advertisement data receiving, selecting and storing steps on the receiving side, that is, on the receiver 40.

D. Steps for receiving, selecting and storing advertisement data on the receiving side:

D1. In step 1, the receiver 40 receives a package of the advertisement data and the additional data, which is transmitted from the transmission part 35 of the host device 30 in wireless manner, by the receiving part 46.

D2. In step 2, the processing/control part 41 compares the audience group specifying category data (Ca1 to Cd3) among the additional data added to each piece of received advertisement data and the data indicating a category to which the audience belongs among the personal data stored on the receiver 40, and, based on results of the comparison, determines whether or not the advertisement data and the additional data to be stored in the storage part 42. In this comparison, categories corresponding to categories indicated in the personal data out of categories included in the audience group specifying category data in the received additional data are extracted, and it is examined whether or not the sponsor selected the categories which were selected by the audience, that is, whether or not a numerical value is assigned to the categories.

In this example, it is assumed that data indicating the categories Ca1 (region A), Cb1 (male), Cc1 (19 years old or under) and Cd3 (hobby C) is included in the personal data stored in the storage part 42. The processing/control part 41 examines the categories Ca1, Cb1, Cc1 and Cd3 in the audience group specifying category data (Ca1 to Cd3) in the received additional data, and examines whether or not the sponsor selected these categories, that is, whether or not numerical values are assigned to those categories.

D2a. If a numerical value other than zero is assigned to any of the above four categories, it is determined that the audience group selected by the sponsor and the audience group to which the audience belongs coincide with each other at least partially, and the processing/control part 41 stores the advertisement data and the additional data in the storage part 42 in step 3.

D2b. If the numerical value zero is assigned to all of the above four categories, it is determined that there is no coincidence, and the processing/control part 41 discards the advertisement data and the additional data without storing them in step 4.

A criterion in the above selection for determining whether or not the advertisement data is stored in the storage part 42 is based on whether or not the numerical value zero is assigned to all of the categories selected by the audience. However, as another method, for example, it is possible to determine whether or not an advertisement is stored based on a total of values assigned to each category selected by the audience. For example, it is possible to define the criterion that only an advertisement having a total value larger than a predetermined value is stored.

Moreover, if the same advertisement has already been received, it is to be discarded.

The storage part 42 of the receiver 40 stores a computer program for performing the above steps.

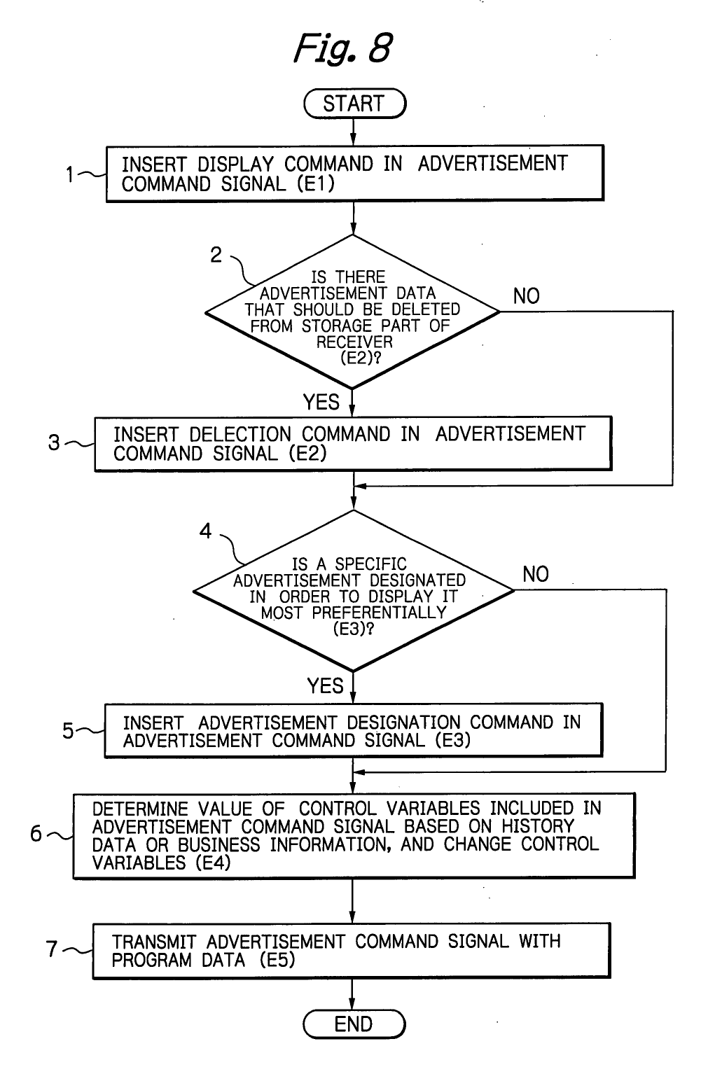

FIG. 8 describes advertisement command signal producing steps on the transmitting side, that is, in the host device 30.

E. Steps for producing an advertisement command signal on the transmitting side:

E1. The host device 30 produces an advertisement command signal to be transmitted together with program (show) data from the transmission part 35. The advertisement command signal includes a display command, a deletion command, a control variable application command, an advertisement designation command and the like.

In step 1, the processing/control part 31 of the host device 30 inserts a display command in an advertisement command signal. The display command is a command for causing the processing/control part 41 of the receiver 40 to read out an advertisement from the storage part 42 and display it. The display command includes a signal indicating that an advertisement time slot begins when a predetermined time (e.g., 10 seconds) passes from the receipt of the advertisement command signal, and a length of the advertisement time slot (e.g., 180 seconds). The above predetermined time is set to be longer than a length of time from a time when the receiver 40 receives the advertisement command signal at the receiving part 46 to a time when the receiver 40 completes preparation for displaying the advertisement.

Also, the length of the advertisement time slot can be freely set in the host device 30 for a program (show) whose schedule is not decided such as a live broadcast.

E2. In step 2, the processing/control part 31 determines whether or not there is advertisement data that should be deleted from the storage part 42 of the receiver 40 and, if there is such advertisement data, inserts a deletion command in the advertisement command signal in step 3. The deletion command is a command for deleting an advertisement whose ordered total number of display has completed, an advertisement for which the data indicating that its continuation is determined to be terminated is stored in the storage part 32 via the input part 33, or the like, from the storage part 42 of the receiver 40. A judgement as to whether or not the ordered total number of display is completed is made based on a result of aggregation of history data fed back from each receiver 40. History data will be described in item H below.

E3. In step 4, the processing/control part 31 determines whether or not it has received an instruction to display a specific advertisement most preferentially. This instruction is issued by a sponsor, and if a specific advertisement is wished to be displayed most preferentially, ID data of the advertisement is inputted from the input part 33 together with the instruction. If the instruction to display the specific advertisement most preferentially is received, and if the ID data of the advertisement has been inputted, the processing/control part 31 prepares an advertisement designation command and inserts it in the advertisement command signal in step 5. The advertisement designation command is a command for instructing that the specific advertisement be displayed most preferentially, and the ID data of the advertisement that should be displayed most preferentially is included in this command.

When the receiver 40 receives the advertisement command signal, if an advertisement designation command is included in it and an advertisement corresponding to the ID data indicated in the advertisement designation command exists in the storage part 42, the advertisement is read out of the storage part 42 and displayed. If the advertisement does not exist, advertisements are displayed according to the priority order.

E4. In step 6, the processing/control part 31 changes a value of the control variable Xn included in the control variable application command of the advertisement command signal, based on the result of collection of the history data fed back from each receiver 40 or business information (including, for example, an instruction from a sponsor). The control variable application command is a command for instructing the processing/control part 41 of the receiver 40 to change a value of a coefficient (a variable Xn) to be applied to each of the six kinds of control coefficients (Tx, Ka, Jn, Cpq, Hx and Fx).

For example, if it is determined from the history data that advertisement data having a large remaining number of displays despite the fact that a display deadline is approaching is stored in the storage part 42 of the receiver 40, in the cases in which a sponsor instructs to promptly complete the ordered number of displays of a specific advertisement, in the case in which it is necessary to promptly complete the display (the ordered number of display) of a specific advertisement due to some reason, or the like, it is necessary to raise the priority order of the advertisement higher in order to display it more. That is, in order to raise the priority order of the advertisement higher, it is necessary to increase a value(s) of the coefficient(s) to be the basis of the priority order. In such a case, a value of the coefficient (variable Xn) applied to each of the six kinds of control coefficients (Tx, Ka, Jn, Cpq, Hx and Fx) is changed, and a value of each control coefficient is varied, whereby the priority order of the display of the object advertisement is raised. A method of determining a control variable will be described in item H5 below.

E5. In step 7, the processing/control part 31 transmits the advertisement command signal from the transmission part 35 to the receiver 40 together with the program (show) data. Although the program data and the advertisement command signal can be transmitted in any wire or wireless broadcasting form, they are multiplexed or superimposed and transmitted in wireless manner.

Timing for transmitting the advertisement command signal is determined based on program (show) schedule data stored in the storage part 32. The program schedule data includes, for example, starting and ending times of an advertisement frame (advertisement slot), and, taking into consideration the time that the receiver 40 requires to read out the stored advertisement and completes preparation for display, the advertisement command signal is transmitted just before the start of the advertisement frame.

In the case of a broadcast whose starting and ending times of an advertisement frame are not decided, such as in the case of a live broadcast, an operator of the host device 30 inputs from the input part 33, at an appropriate time, an instruction to transmit the advertisement command signal.

The storage part 32 of the host device 30 stores a computer program for performing the above steps.

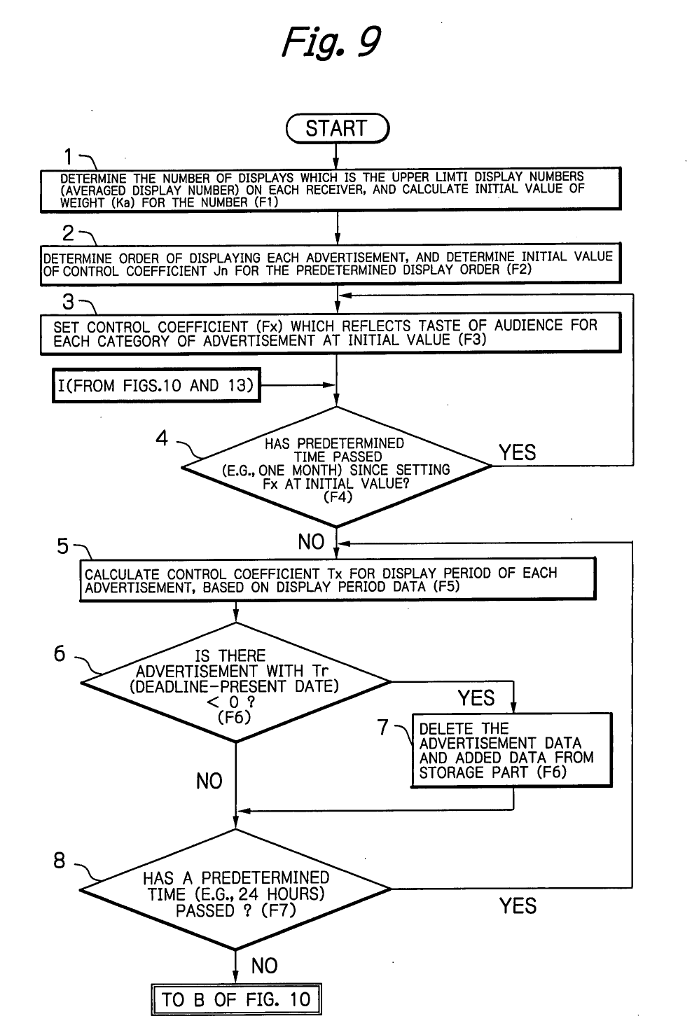

FIGS. 9, 10, 11, 12 and 13 show one continuous flow chart and describe steps for determining a priority order of stored advertisement data and displaying advertisements on the receiving side, that is, on the receiver 40.

F. Steps for determining a priority order of stored advertisement data and displaying advertisements on the receiving side:

F1. In step 1 of FIG. 9, the processing/control part 41 of the receiver 40 determines an initial value of a value representing a weight for the averaged display number of each advertisement stored on each receiver (the control coefficient Ka of FIG. 1), based on the averaged display number data (the averaged display number) in the additional data of the advertisement data that was received from the host device 30 and stored in the storage part 42. The control coefficient Ka is obtained by multiplying the remaining number of displays until the averaged display number is reached by a coefficient (i.e., Ka=remaining number of display x coefficient). For example, if a value of the control coefficient Ka is desired to be the same as a value of the remaining number of display, the coefficient to multiply the remaining number of display is set to 1 and a value of a control variable X7 to be applied later in step 23 is set to 1.

One is deducted from the remaining number of displays each time the advertisement is displayed. When the remaining number of display reaches zero, the control coefficient Ka becomes zero. An advertisement with its control coefficient Ka reached zero is not displayed any more.

In the example of FIG. 1, the values of the control coefficient Ka is 40 for CM1, 100 for CM2, 50 for CM3, 40 for CM4, 70 for CM5, and 30 for CM6. In the case that the processing/control part 41 determines a priority order of advertisement based only on the values of the control coefficient Ka at this point, the priority order is CM2, CM5, CM3, CM1 and CM4, and CM6 from the top.

F2. In step 2, the processing/control part 41 predetermines an order for displaying each stored advertisement and determines an initial value of a value representing a weight for the predetermined display order (the control coefficient Jn of FIG. 1).

An initial predetermined display order may be determined by any appropriate method. For example, a method of assigning a higher predetermined display order to an advertisement stored earlier, a method of assigning a predetermined display order in the order of an alphabet or the number of an ID number added to each advertisement data, or the like may be used.

In assigning an initial control coefficient Jn, a control coefficient for an advertisement of the lowest predetermined display order is set to be a predetermined minimum value, and a predetermined increment value is added each time the predetermined display order is up by one. In the example of FIG. 1, the minimum value of the control coefficient Jn is set to 1,000, and the increment value is set to 100. In the example of FIG. 1, CM6 is the lowest in the predetermined display order, thus, the value of its control coefficient is 1,000. The predetermined display order of CM5 is the second lowest, and the value of its control coefficient is 1,000+100, that is, 1,100. The predetermined display order of CM4 is the third lowest, and the value of its control coefficient is 1,100+100, that is, 1,200. The value of the coefficient that is calculated in the similar manner is 1,500 for CM1, 1,400 for CM2 and 1,300 for CM3.

The control coefficient Jn of each advertisement is updated when the advertisement is displayed. That is, the processing/control part 41 makes the value of the control coefficient Jn for the displayed advertisement lower, and makes the value of the control coefficient Jn for advertisements that are not shown higher. A method of updating the control coefficient Jn will be described in detail in item F22 below.

In the case that the processing/control part 41 determines a priority order of advertisements based only on the value of the control coefficient Jn at this point, the priority order is CM1, CM2, CM3, CM4, CM5 and CM6 from the top.

F3. In step 3, the processing/control part 41 assigns an initial value to a value reflecting a taste (preference) of an audience (the control coefficient Fx) for a field of each stored advertisement (advertisement attribute). That is, initially, the processing/control part 41 of the receiver 40 assigns a same initial value to all the advertisement attributes and stores it in the storage part 42.

The input part 43 of the receiver 40 is provided with voting buttons with which an audience expresses (votes on) whether the audience likes or dislikes an advertisement that the audience is viewing/listening to (“like button” and “dislike button”). When an audience presses the “like button” while an advertisement is displayed, values of the control coefficient Fx for all advertisement having the same advertisement attribute as the advertisement attribute of the advertisement are increased. When an audience presses the “dislike button,” values of the control coefficient Fx for all advertisement having the same advertisement attribute as the advertisement attribute of the advertisement decreases. Operations for these voting buttons will be described in detail in item F23 below (description of step 33).

For the value of the control coefficient Fx, an upper limit value is set such that it does not increase too much, that is, the priority of an advertisement(s) having a specific advertisement attribute does not become too high, and a lower limit value is set such that the priority of an advertisement(s) having a specific advertisement attribute does not become too low. The above initial value is set at, for example, a value in the middle of the upper limit value and the lower limit value.

In the example of FIG. 1, the initial value is 50, the lowest limit value is 0, and the upper limit value is 100, and, in FIG. 1, the values of the control coefficients Fx for attributes of respective advertisements after the voting buttons are pressed a plurality of times are indicated. In FIG. 1, the value of the control coefficient Fx for the advertisement attribute (F1) of the advertisements CM1, Cm2 and CM4 is 70, which indicates that the “like button” has been pressed more. The value of the control coefficient Fx for the advertisement attribute (F2) of CM3 and CM6 is 20, which indicates that the “dislike button” has been pressed more. The value of the control coefficient Fx for the advertisement attribute (F3) of CM5 is 50, which indicates that the voting buttons have not been pressed or the “like button” and the “dislike button” have been pressed the same number of times. In the case that a priority order of advertisements is determined based only on the values of the control coefficient Fx at this point, CM1, CM2 and CM4 at the top, CM3 and CM6 are at the second place, and CM5 is at the third place of the priority order.

F4. In step 4, the processing/control part 41 determines whether or not a predetermined period (for example, one week, one month, etc.) has passed after setting the control coefficient Fx at an initial value, based on the data which is the basis of date and time and is obtained from a timing part 44. If the predetermined period has passed, the operation step returns to step 3 and resets the control coefficient Fx for all the advertisements to the initial value. If the predetermined period has not passed, the operation step proceeds to step 5.

If a value of the control coefficient Fx for an advertisement having a specific attribute is maintained to be high over a certain period, the other advertisements tend to be displayed less during the period. Also, to the contrary, if a value of the control coefficient Fx for an advertisement having a specific attribute is maintained to be low over a certain period, the advertisement tends to be displayed less during the period. When the efficiency of advertisements is taken into consideration, it is not preferable to maintain a biased displaying period of advertisements reflecting a taste of an audience, as described above, excessively long. Therefore, the control coefficient Fx for every advertisement is reset to an initial value when a predetermined period has passed.

Also, it may be possible to configure the system such that, when the control coefficient Fx for any advertisement attribute reaches an upper limit value or a lower limit value, the control coefficient Fx for every advertisement is reset to an initial value. By this configuration, for example, a situation in which a value of the control coefficient Fx only for an advertisement having a specific attribute is increased and the priority of the advertisement becomes higher, whereby display of the other advertisements is excessively disturbed, can be prevented. In addition, to the contrary, a situation in which a value of the control coefficient Fx only for an advertisement having a specific attribute is decreased and the priority of the advertisement becomes lower, whereby the display of the advertisement is excessively disturbed, can be prevented.

F5. In step 5, the processing/control part 41 determines a value representing a weight for a display period of each stored advertisement, that is, a weight for a remaining display period (the control coefficient Tx of FIG. 1) based on the display period data in the additional data of the advertisement data stored in the storage part 42. The control coefficient Tx is calculated as described below.

i. A total display period (Tt) is obtained based on the date of a deadline of display and the data when an advertisement is sent to a receiver.

Tt=(Deadline date)−(Advertisement transmitted date)

ii. A remaining display period (Tr) is obtained based on the date of the deadline of display and the present date.

Tr=(Deadline date)−(Present date)

iii. A ratio of the remaining display period to the total display period is obtained, and the ratio is multiplied by a coefficient (1,000 in this example) to obtain a value Tx′.

Tx′=(Tr/Tt)×1,000

The shorter the remaining display period the smaller the value Tx′ becomes.

iv. The period coefficient Tx′ is subtracted from a predetermined coefficient (1,000 in this example) to obtain a period coefficient Tx.

Tx=1,000−Tx′

Data to be the basis of date and time in calculating the remaining display period is generated in the timing part 44. If a display period is calculated by a unit of one day, the processing/control part 41 calculates the control coefficient Tx and updates the value every time one day passes (i.e., everyday) (see step 8). The control coefficient Tx becomes a maximum value (1,000) when the remaining display period reaches zero.

However, there may be an advertisement for which the display period is only one day and, in this case, the date of the deadline of display and the date when an advertisement is transmitted (the date to start displaying of the advertisement) become the same. In such a case, the value of the total display period (Tt) obtained in the above step i is zero. If Tt=0, an answer for the expression of the following step iii cannot be obtained. Therefore, the processing/control part 41 determines whether Tt is zero or not immediately after the above step i. If Tt is zero, the processing/control part 41 assigns a maximum value to the control coefficient Tx without performing the above steps ii to iv, and if Tt is not zero, the processing/control part 41 performs the above steps ii to iv to calculate Tx.

In the example of FIG. 1, the value of the control coefficient Tx is 800 for CM1, 700 for CM2, 400 for CM3, 300 for CM4, 500 for CM5, and 100 for CM6. In the case that the processing/control part 41 determines a priority order of the advertisements based only on the values of the control coefficient Tx at this point, the priority order is CM1, CM2, CM5, CM3, CM4 and CM6 from the top.

F6. In step 6, the processing/control part 41 examines each advertisement to find if an advertisement for which value of Tr (a value obtained in step ii of the above step 5), that is, the value obtained by subtracting the present date from the date of the deadline is smaller than zero is stored. If there is an advertisement for which Tr<0, the advertisement data and additional data is deleted from the storage part 42 in step 7. Note that the ID data of the advertisement and history data concerning the display states of the advertisement (which will be described in the description below) stored in the storage part 42 is retained in the storage part 42 until it is transmitted to the host device 30.

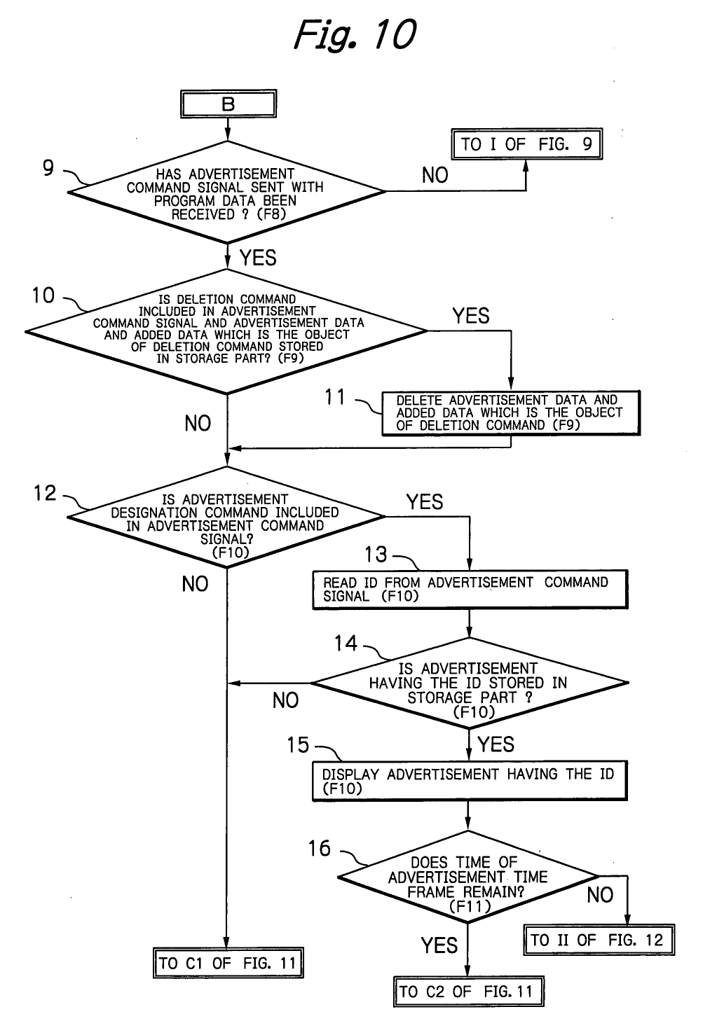

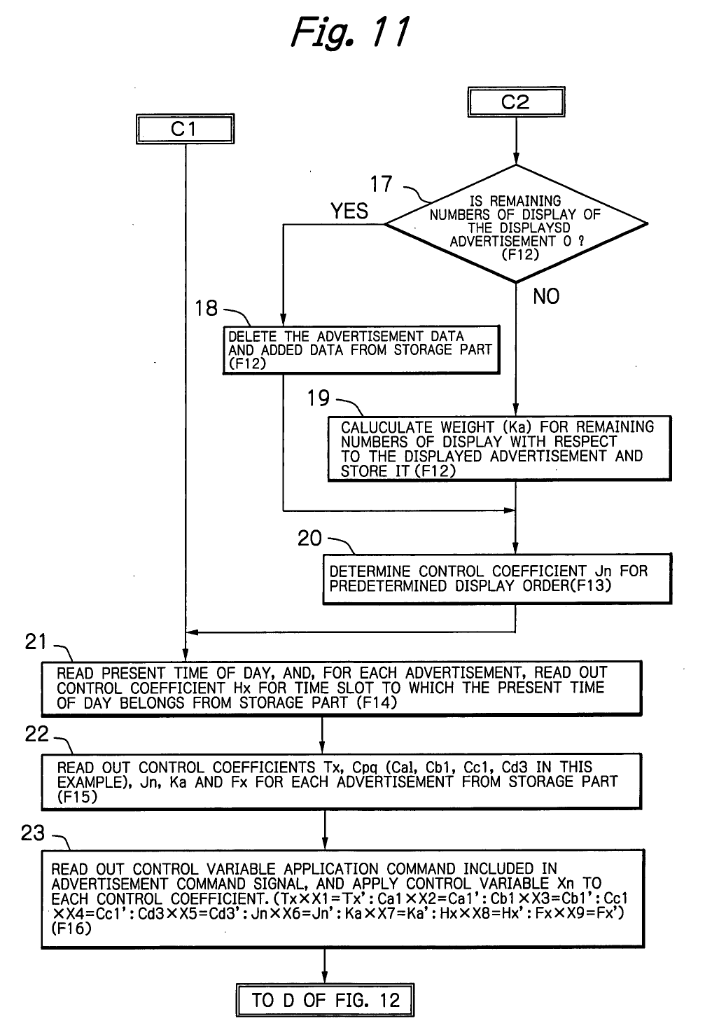

F7. Next, in step 8, the processing/control part 41 examines whether or not a predetermined time, for example, one day has passed, based on the data to be a basis of date and time obtained from the timing part 44. If the predetermined time has passed, the operation of the processing/control part 41 returns to step 5, and the control coefficient Tx is calculated again. If the predetermined time has not passed, the operation proceeds to step 9 of FIG. 10.

F8. In step 9 of FIG. 10, the receiver 40 waits for an advertisement command signal to be transmitted with program (show) data from the transmission part 35 of the host device 30. If the receiving part 46 of the receiver 40 has not received the advertisement command signal, the operation of the receiver 40 returns to step 4 of FIG. 9, and repeats the steps from step 4. When the receiver 40 receives the advertisement command signal at the receiving part 46, the operation proceeds to step 10. The advertisement command signal includes a display command, a deletion command, a control variable application command, an advertisement designation command and the like. The processing/control part 41 of the receiver 40 reads out these commands from the advertisement command signal and performs processing in accordance with the commands.

F9. In step 10, if the processing/control part 41 determines that a deletion command is included in the advertisement command signal received by the receiving part 46, and that advertisement data and additional data of an advertisement designated by the deletion command are stored in the storage part 42, the processing/control part 41 deletes the advertisement data and the additional data being the object of deletion from the storage part 42 in step 11. Note that the advertisement ID data and the history data are retained until they are transmitted to the host device 40.

If a deletion command is not included in the advertisement command signal, or if a deletion command is included but an advertisement being the object of deletion is not stored in the storage part 42, the operation directly proceeds to step 12.

F10. In step 12, the processing/control part 41 determines whether or not an advertisement designation command is included in the advertisement command signal. If an advertisement designation command is not included, the operation proceeds to step 21 (F14) of FIG. 11.

If an advertisement designation command is included, the processing/control part 41 reads out ID data included in the advertisement designation command in step 13, and determines whether or not an advertisement having the ID data is stored in the storage part 42 in step 14. If it is determined in step 14 that the advertisement designated by the advertisement designation command is not stored in the storage part 42, the operation proceeds to step 21 of FIG. 11 (F14). If it is determined that the advertisement is stored, in step 15, the processing/control part 41 reads out the advertisement from the storage part 42, responds to a display command included in the advertisement command signal, and displays the advertisement most preferentially on the sound/image output device 48 in an advertisement time frame which starts at a time designated by the display command. Next, the operation proceeds to step 16.

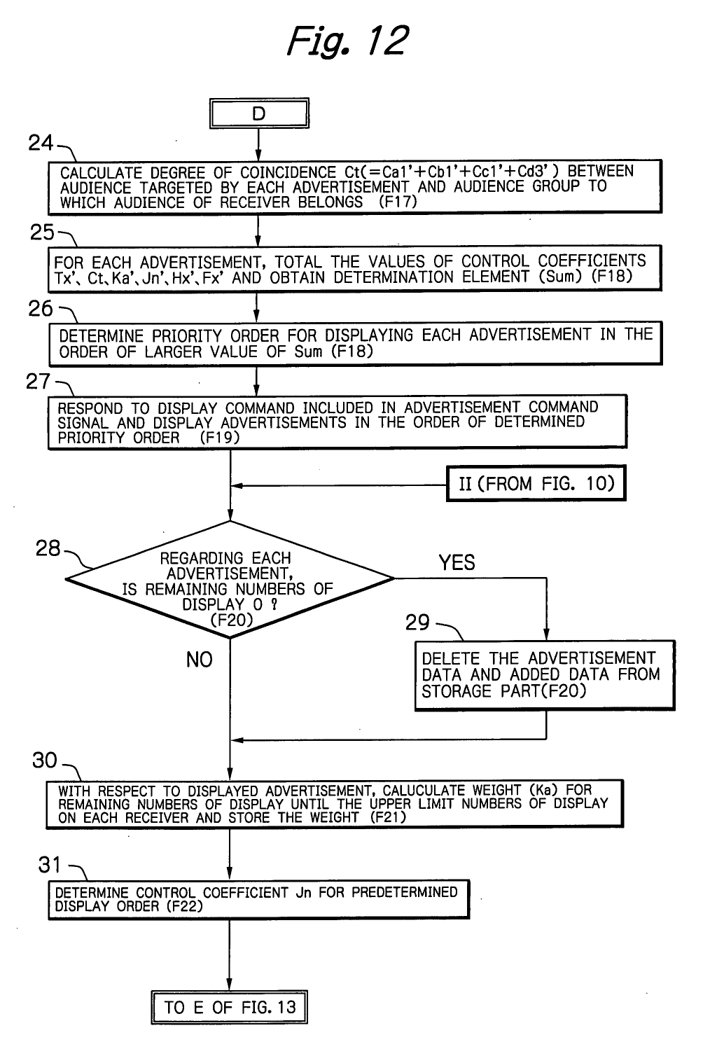

F11. In step 16, the processing/control part 41 of the receiver 40 subtracts the length (display time) of the advertisement designated by the advertisement designation command from the length of the advertisement time frame specified by the display command included in the advertisement command signal, and determines whether or not the advertisement time frame remains. If the processing/control part 41 determines that a time in which another advertisement can be displayed does not remain, the operation proceeds to step 28 of FIG. 12. If the processing/control part 41 determines that a time in which another advertisement can be displayed remains, the operation proceeds to step 17 of FIG. 11.

F12. In step 17 of FIG. 11, the processing/control part 41 of the receiver 40 subtracts one from the remaining number of display of the advertisement which is designated by the advertisement designation command and displayed, and determines whether or not the remaining number of display is zero. If it is determined that the remaining number of display is zero, the advertisement data and the additional data of the advertisement are deleted from the storage part 41 in step 18. The advertisement ID data and the history data of the advertisement are retained until they are transmitted to the host device 40. If the advertisement data and the additional data of the advertisement are deleted in step 18, the operation proceeds to step 20.

In step 17, if it is determined that the remaining number of display is not zero, the operation of the processing/control part 41 proceeds to step 19. In step 19, the weight for the remaining number of display (the control coefficient Ka) with respect to the advertisement is calculated and stored in the storage part 42.

F13. Next, in step 20, the processing/control part 41 updates a value representing a weight for a predetermined display order of each stored advertisement (the control coefficient Jn). The processing/control part 41 maintains without change the control coefficient Jn of an advertisement(s) which is ranked higher in the predetermined display order than the advertisement displayed in step 15, makes the control coefficient of the advertisement displayed in step 15 a minimum value, and adds an increment value (100) to the control coefficient for each advertisement which is ranked lower in the predetermined display order than the advertisement displayed in step 15 to increase the value of the control coefficient Jn for each advertisements by the amount for one rank. (A method of updating the control coefficient Jn will be described in detail in item F22 below.)

Note that steps 16 to 20 can be performed while the advertisement designated by the advertisement designation command is displayed.

F14. In step 21, the processing/control part 41 reads out a present time from the timing part 44. The processing/control part 41 then reads a control coefficient (Hx) assigned to a time slot to which the present time belongs out of the control coefficients (Hx) assigned respectively to a plurality of time slots (H1 to H6) in the preferred display time data included in the additional data of each advertisement stored in the storage part 42.

In the example of FIG. 1, for example, for the time slot H6 (2100 hours to 0100 hours), values 0, 20, 0, 20, 30 and 0 are assigned to CM1, CM2, CM3, CM4, CM 5 and CM6, respectively. These control coefficients assigned to the time slot H6 are only effective during the time between 21 o'clock and 1 o'clock in one day, and increase the priorities of CM2, CM4 and CM5 during this time slot. A sponsor can designate to some extent a time slot(s) during which an advertisement is displayed, by using this control coefficient Hx.

For example, in the case that the present time is 22 o'clock and the processing/control part 41 determines a priority order of advertisements based only on the values of the control coefficients Hx at the point, CM5 is at the top, CM2 and CM4 are at the second place, and CM1, cM3 and CM6 are at the third place.

F15. Next, in step 22, the processing/control part 41 reads out all control coefficients Tx, Cpq, Jn, Ka, Hx and Fx for each advertisement. In this example, since the audience of the receiver belongs to the categories Ca1, Cb1, Cc1 and Cd3 in the audience group specifying category data, the values of Ca1, Cb1, Cc1 and Cd3 are read out with respect to Cpq.

F16. In step 23, the processing/control part 41 reads out the control variable application command from the advertisement command signal, and applies variable values (Xn) designated by the control variable application command to the control coefficients (Tx, Cpq, Jn, Ka, Hx and Fx) only for that time to determine a new control coefficient. That is, the processing/control part 41 reads out the control variables X1 to X9 from the control variable application command, and multiply corresponding control coefficients by each control variable to calculate values of new control coefficients, Tx′ (=Tx×X1), Cax′ (=Cax×X2), Cbx′ (=Cbx×X3), Ccx′ (=Ccx×X4), Cdx′ (=Cdx×X5), Jn′ (=Jn×X6), Ka′ (=Ka×X7), Hx′ (=Hx×X8) and Fx′ (=Fx×X9). If it is desired for a value of a certain control variable not to be changed, a value of the control variable Xn for the control coefficient is set to one.

It is desirable that this step is performed before a step for calculating the value of the degree of coincidence Ct (see step 24, F17) and a step for totaling the values of all the control coefficients (Tx, Cpq (Ct), Ka, Jn, Hx and Fx) (see step 25, F18). By the processing in this step 23, it becomes possible to control which calculation element should be attached importance from the host side.

The operation continues to step 24 of FIG. 12.

F17. In step 24, the processing/control part 41 determines the value indicating a weight for a degree of coincidence (the degree of coincidence value Ct) between an audience group targeted by each stored advertisement and an audience group to which an audience of a receiver belongs, based on the audience group specifying category data in the additional data of the advertisement data stored in the storage part 42.

The degree of coincidence Ct is obtained by totaling numerical values assigned to categories (i.e., numerical values obtained by applying a control variable to the numerical values), among all the categories of the audience group specifying category data (Ca1 to Cd3) included in the additional data of each advertisement data stored in the storage part 42, that coincide with categories to which the audience belongs.

The above audience belongs to the categories Ca1, Cb1, Cc1 and Cd3. Also, in this example, it is assumed that values of the control variables (X2, X3, X4 and X5) applied to Cpq (Cax, Cbx, Ccx and Cdx) in the above step 23 were all one. In this case, as shown in the table in the lower part of FIG. 1, the numerical value Ct (=Ca1′+Cb1′+Cc1′+Cd3′) representing the degree of coincidence for CM1 of the above audience is 40+80+10+10=140. Similarly, the numerical value Ct is 250 for CM2, 110 for CM3, 200 for CM4, 90 for CM5 and 170 for CM6.

In the case that the processing/control part 41 determines a priority order of advertisements based only on these values of the control coefficients Ct's, the priority order is CM2, CM4, Cm6, CM1, CM3 and CM5 from the top.

F18. In step 25, the processing/control part 41 totals the values of control coefficients Tx′, Ka′, Jn′, Hx′ and Fx′ and Ct for each advertisement to obtain a determination element (the determination element (Sum) of FIG. 1). Next, in step 26, based on this determination element (Sum), the processing/control part 41 determines a final priority order (the priority order (N) of FIG. 1) for displaying each advertisement in the order of the value of the determination element.

In the case of the example of FIG. 1, that is, in the case in which an audience of a receiver belongs to the categories Ca1, Cb1, Cc1 and Cd3, a present time belongs to the time slot H6, and all the control variables Xn (X1 to X9) are one, values of the determination elements (Sum) of CM1 to CM6 are 2,550, 2,540, 1,880, 1,830, 1,840 and 1,320, and the priority order N (the first to sixth places) based on the determination elements Sum is CM1, CM2, Cm3, CM5, CM4 and CM6 from the top.

F19. Next, in step 27, the processing/control part 41 responds to the display command included in the advertisement command signal; reads out advertisement data, that can be displayed during a designated time frame from a designated time, from the storage part 42 in the order of the determined priority order; and outputs the advertisement data from the sound/image information output part 47 to the sound/image output device 48 to display the advertisement.

If an advertisement is displayed in the above step 15, the processing/control part 41 reads out advertisement data that can be displayed in the remaining time of the advertisement time frame from the storage part 42 in the order of the determined priority order, and outputs it from the sound/image information output part 47 to the sound/image output device 48 to display the advertisement from the time immediately after ending the display of the advertisement in step 15.

The processing/control part 41 subtracts a value of the number of display (usually one) from the value of the remaining number of display with respect to the displayed advertisement, and stores the updated remaining number of display in the storage part 42.

F20. In step 28, the processing/control part 41 examines the remaining number of display of each advertisement and, if there is an advertisement for which the remaining number of display is zero, deletes advertisement data and additional data of the advertisement from the storage part 42 in step 29. The ID data of the advertisement and the history data concerning the display states of the advertisement stored in the storage part 42 are maintained in the storage part 42 until they are transmitted to the host device 30.

F21. For each advertisement for which remaining number of display is determined to be not zero in the above step 28, the processing/control part 41 calculates a value representing the weight for the remaining number of display (the control coefficient Ka) and stores the value in the storage part 42 in step 30.

F22. In step 31, the processing/control part 41 updates a value representing the weight for the predetermined display order of each stored advertisement (the control coefficient Jn).

For example, if an advertisement at the first place of the predetermined display order has been read out from the storage part 42 and displayed on the sound/image output device 48 via the sound/image information output part 47, the processing/control part 41 sets the control coefficient for the advertisement to the minimum value (1,000), and adds the above increment value to the control coefficient for each advertisement in the second place or lower in the predetermined display order to increase the value of the control coefficient Jn by the amount for raising one place. In this example, if CM1 is displayed, the control coefficient of CM1 is changed to the minimum value of 1,000, and 100 is added to each of the control coefficients of CM2 to CM6. As a result, the values of the control coefficients for CM2, CM3, CM4, CM5, CM6 become 1,500, 1,400, 1,300, 1,200, 1,100, respectively. The priority order of display for the next time based only on the updated control coefficient Jn is CM2, CM3, CM4, CM5, CM6 and CM1 from the top.

Also, for example, if the advertisement time frame is long, and the processing/control part 41 sequentially reads out a plurality of advertisements from the storage part 42 in the order of the priority order based on the control coefficient Jn and sequentially displays the advertisements on the sound/image output device 48 through the sound/image information output part 47, the processing/control part 41 collectively recalculates the control coefficient Jn after ending the display. For example, it is assumed that the advertisements are in the order of CM1, CM2, CM3, CM4, CM5 and CM6 from the highest to the lower values of the control coefficients Jn, and CM1 to CM3 are sequentially read out and displayed in the order. In this case, the processing/control part 41 moves CM1 to CM3 collectively to the last place in this order, and assigns control coefficients in the manner similar to the above. That is, the control coefficients of CM 1, CM2 and CM3 are set to 1,200, 1,100 and 1,000, respectively. Since each of the orders for CM4, CM5 and CM6 is raised up by three places, an increment value for the three places (300) is add to their original control coefficients, respectively.

Note that when the processing/control part 41 uses a plurality of determination elements in determining a priority order of display, other determination elements (one or more) may be prioritized. Thus, even if the advertisements are in the order of CM1, CM2, CM3, CM4, CM5 and CM6 from the one with a higher value of the control coefficient Jn, an advertisement having an intermediate control coefficient value Jn, for example, CM3 may be read out and displayed earlier. In addition, if an advertisement designation command is included in the advertisement display command, and the advertisement designation command designates, for example, CM3, the processing/control part 41 reads out and displays CM3 most preferentially without taking any control coefficient value into consideration (i.e., even if the control coefficient value Jn of CM3 is not the maximum value). In these cases, the control coefficients Jn, which are in places higher than that of CM3, of the advertisements, that is, those of CM1 and CM2 in this example, are maintained as they are; the minimum value 1,000 is assigned to CM3; and the increment value 100 is added to the control coefficient Jn of each of the advertisements having the control coefficient Jn in a place lower than that of CM3, that is, CM4, CM5 and CM6 in this example. As a result, the priority order of the next display based only on this control coefficient becomes CM1, CM2, CM4, CM5, CM6 and CM3 from the top.

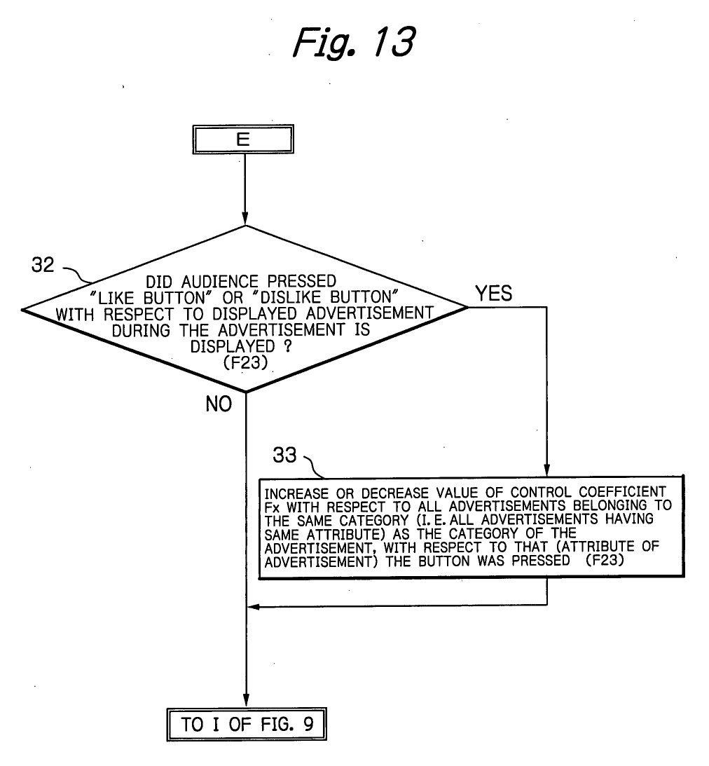

The operation continues from step 31 of FIG. 12 to step 32 of FIG. 13.

F23. In step 32 of FIG. 13, the processing/control part 41 examines whether or not the voting buttons of the input part 43 of the receiver 40 have been pressed while the advertisement is displayed.

When an audience presses the “like button” while the advertisement is displayed, that is, votes “like,” the processing/control part 41 stores, in the storage part 42, voting information indicating that the audience voted “like” with respect to the advertisement attribute of the advertisement. When an audience presses the “dislike button,” that is, votes “dislike,” the processing/control part 41 stores, in the storage part 42, voting information indicating that the audience voted “dislike” with respect to the advertisement attribute of the advertisement. Also, the processing/control part 41 stores only one vote in the storage part 42 as an effective vote even if the audience votes a plurality of times while one advertisement is displayed.

The processing/control part 41 reads out the voting information stored in the storage part 42 after displaying the advertisement. If the voting information indicating that the audience pressed the “like button,” that is, voted “like” while the advertisement is displayed is stored, the processing/control part 41 increases the control coefficient Fx for all advertisements having the same advertisement attribute as the advertisement attribute of the displayed advertisement by a predetermined value in step 33. To the contrary, if the voting information indicating that the audience pressed the “dislike button,” that is, voted “dislike” is stored, the processing/control part 41 decreases the control coefficient Fx for all advertisements having the same advertisement attribute as the displayed advertisement attribute of the advertisement by a predetermined value in step 33.

For example, in the example of FIG. 1, the advertisement attribute of the advertisements CM1, CM2 and CM4 is F1 (for example, car), the advertisement attribute of CM3 and CM6 is F2 (for example, food), and the advertisement attribute of CM5 is F3 (for example, cosmetic). In addition, the initial value, the upper limit value and the lower limit value of the control coefficient Fx are set at 50, 100 and 0, respectively.

If an audience presses the “like button” when the audience views/listens to CM1 which is an advertisement of a car, the numerical value for the advertisement attribute F1 to which CM1 belongs increases by a predetermined value, and the priority of the advertisement becomes higher than that of advertisements having other advertisement attributes. That is, the priorities of the advertisements of cars, CM1, CM2 and CM4 become higher than those of CM3, CM5 and CM6. If an audience presses the “dislike button” when the audience views/listens to CM3 which is an advertisement of food, the numerical value for the advertisement attribute F2 to which CM3 belongs decreases by a predetermined value, and the priority of the advertisement becomes lower than those of advertisements having other advertisement attributes. That is, the priorities of the advertisements of foods, CM3 and CM6 become lower than those of CM1, CM2, CM4 and CM5. If the buttons are not pressed while an advertisement is displayed, the control coefficient Fx for the advertisement attribute for the advertisement does not change.

In addition, to an advertisement that is distributed anew, the processing/control part 41 assigns a corresponding present control coefficient Fx on the receiver 40. For example, if the advertisement attribute of an advertisement CMX that is distributed anew is F1 and the value of the present control coefficient Fx for the advertisement attribute F1 on the receiver 40 is 70, value 70 is assigned to the advertisement attribute F1 of the advertisement CMX.

After step 33, the operation step returns to step 4 of FIG. 9, and performs operations similar to those described above.

The storage part 42 of the receiver 40 stores a computer program for performing the above steps.

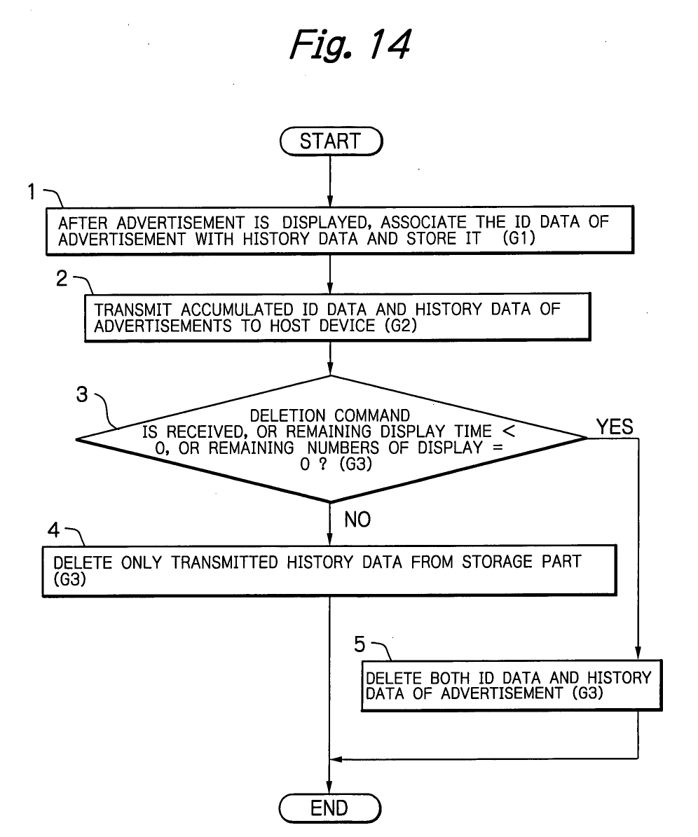

FIG. 14 describes steps on the receiving side, that is, on the receiver 40, for storing history data concerning display of an advertisement.

G. Steps for storing history data concerning display of an advertisement on the receiving side:

G1. On each receiver 40, when an advertisement is displayed, the processing/control part 41 stores history data in association with ID data of the advertisement stored in the storage part 42, in step 1. The history data includes data indicating the number of times that the advertisement was displayed.

If more detailed data is required, the receiver 40 constructs, for each advertisement, history data including a date and time when the advertisement was displayed and a channel number that was tuned at that time, the number of times the advertisement was displayed for each channel, the total number of times the advertisement was displayed, an ID number of a transmitting device (audience) that transmitted the history data, an attribute of the audience and the like.

G2. In step 2, upon receiving a history data transmission command transmitted from the transmission part 35 of the host device 30 at the receiving part 46, the receiver 40 transmits accumulated ID data and history data of the advertisements from the transmission part 45 to the receiving part 36 of the host device 30 through the line 39.

Alternatively, in step 2, the system may be configured such that the receiver 30 voluntarily and periodically transmits the accumulated ID data and history data of the advertisements to the host device 30.

The host device 30 stores the history data received at the receiving part 36 in the storage part 32.

G3. After transmitting the ID data and the history data of the advertisement to the host device 30, the processing/control part 41 examines whether or not a deletion command has been issued to the advertisement stored in the storage part 42, whether or not the remaining display period has become less than zero (Tr<0), and whether or not the remaining number of displays has become zero (i.e., whether Ka=0 or not) in step 3.

With respect to an advertisement for which a deletion command has not been issued, the remaining display period is zero or more, and the remaining number of displays is more than zero, the processing/control part 41 maintains the ID data of the advertisement as it is and deletes the transmitted history data only from the storage part 42 in step 4.

With respect to an advertisement that has received a deletion command, an advertisement for which the remaining display period is less than zero, and an advertisement for which the remaining number of display is zero, the processing/control part 41 deletes both the ID data and the history data of the advertisement from the storage part 42 in step 5.

The storage part 42 of the receiver 40 stores a computer program for performing the above steps.

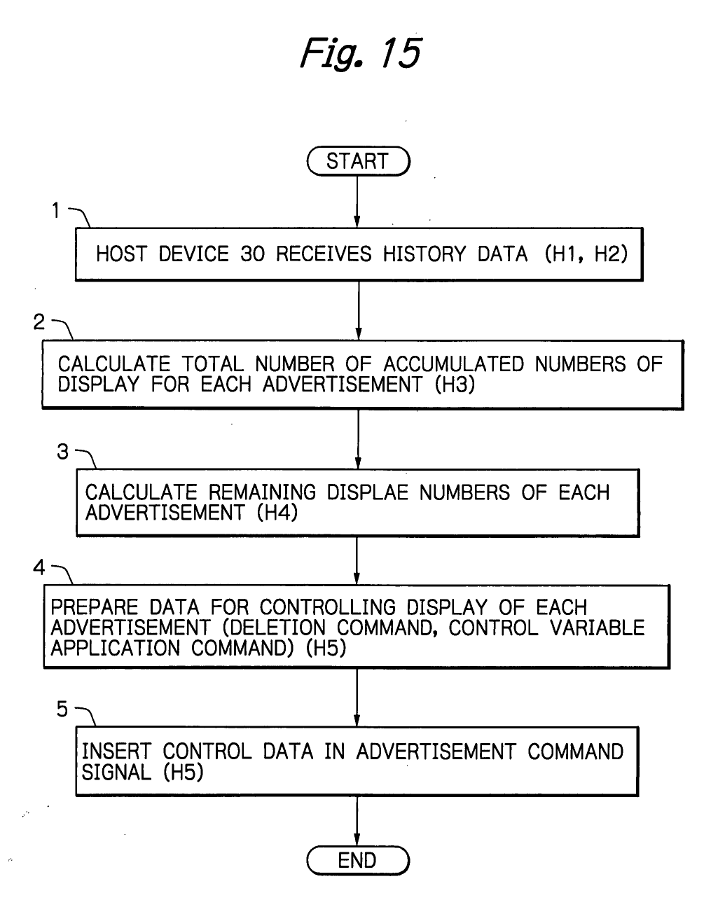

FIG. 15 describes steps on the transmitting side, that is, in the host device 30, for processing and controlling history data fed back from the receiver 40.

H. Steps on the transmitting side for processing and controlling history data fed back from the receiving side:

H1. In step 1, the host device 30 transmits a history data transmission command from the transmission part 35 to each receiver 40 and causes the processing/control part 41 of the receiver 40 to read out the history data from the storage part 42 and transmit the history data from the transmission part 45. Alternatively, the system may be configured such that the receiver 40 voluntarily and periodically transmits history data.

H2. The host device 30 receives the history data transmitted from the transmission part 45 of each receiver 40 through the line 39 by the receiving part 36 and stores the history data in the storage part 32.

H3. In step 2, the processing/control part 31 first obtains a total of the number of times each advertisement was displayed in all the receivers 40, based on the history data received at this time. Then, the processing/control part 31 adds the total number of displays of this time and the total number of display derived by accumulating the previously obtained history data stored in the storage part 32, thereby obtaining the number of times each advertisement was displayed in all the receivers at this point.

H4. In step 3, the processing/control part 31 compares the number of times each advertisement was displayed in all the receivers 40, which was obtained in the above item H3 and the total number of displays defined at the time of receiving an order of the advertisement, and finds a remaining number of displays of each advertisement.

H5. In step 4, based on the remaining number of displays found in the above item H4, the processing/control part 31 generates control data for display of each advertisement and, in step 5, includes the control data in an advertisement command signal. The processing steps in the processing/control part 31 are as follows.

H5a. If the remaining number of displays becomes zero or less, the processing/control part 31 includes a deletion command for the advertisement in the next advertisement command signal.

H5b. If the remaining number of display is not zero, the processing/control part 31 first finds the number of displays per a unit time that is required for attaining the total number of displays during the remaining display period.

First, the number of displays per a unit time (the actual number of displays) from the number of times an advertisement was displayed in a certain period. For example, the number of times the advertisement was displayed from the date when the advertisement data was transmitted until the date when the history data was obtained is divided by the number of days during the period to find the number of times the advertisement was displayed in one day. Then the actual number of displays and the required number of displays are compared and, if the required number of display is larger, a value of a control variable Xn included in a control variable application command of the next advertisement command signal is changed in order to make the priority order of the advertisement higher.

Which control variable (Xn) corresponding to which control coefficient is changed may be determined experientially or, after time has passed since the system was operated, may be determined based on the obtained statistical data; and the basis of determination may be stored in the storage part 32. Alternatively, it is also possible, according to the situation, to input data indicating what kind of control variable (Xn) is applied to what kind of control coefficient from the input part 33, and insert the data in the advertisement command signal in the processing/control part 31.

For example, in the example of FIG. 1, it is assumed that the priority order of an advertisement having a short remaining display period is desired to be made higher. In this case, the value of the control variable X1 included in the control variable application command is increased. For example, the value of the control variable X1 applied to the control coefficient Tx of FIG. 1 is set to 10. When the control coefficient Tx is multiplied by the control variable 10, determination elements (Sum) of CM1 to CM6 become 9,750, 8,840, 5,480, 4,530, 6,340 and 2,220, respectively. The priority order based on these determination elements is CM1, CM2, CM5, CM3, CM4 and CM6 from the top. In this example, the priority order of CM1 which has the shortest remaining display period (i.e., having the largest value of the control coefficient Tx) is at the top, and the priority order of CM2 having the second shortest remaining display period is positioned at the second place. Although the newly determined priority order of CM1 and CM2 is the same as the original priority order, it is in the order of shortness of the remaining display period. The priority order of the advertisement CM5 which has the third shortest remaining display period is up one rank from the fourth place to the third place, and the priority order of the advertisement CM3 having the fourth shortest remaining display period is down one rank from the third place to the fourth place. In order to attach more importance to an advertisement having a short remaining period, a larger control variable is multiplied to the control coefficient thereof.

The way in which a priority order goes up changes depending on a control variable (Xn) to multiply.

The storage part 32 of the host device 30 stores a computer program for performing the above steps.

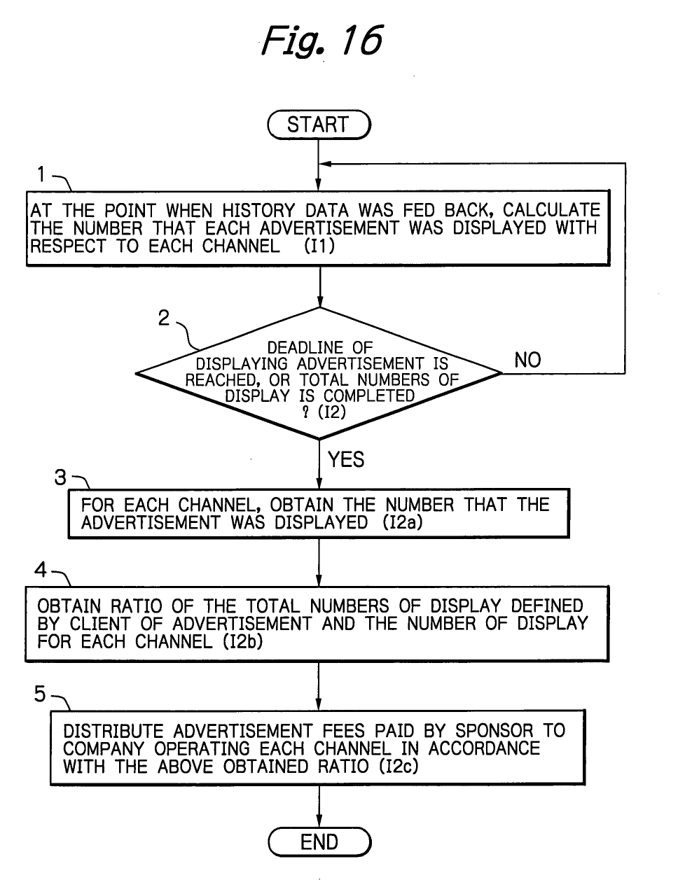

FIG. 16 describes steps on the transmitting side, that is, the host device 30, for generating statistical data based on history data fed back from the receiving side, that is, the receiver 40.

I. Steps on the transmitting side for generating statistical data based on history data fed back from the receiving side:

I1. If data indicating the number of times an advertisement was displayed for each channel is included in the history data which is received at the receiving part 36 and stored in the storage part 32, the processing/control part 31 adds, for each advertisement, the total number of times the advertisement was displayed for each channel, which was found from the previously obtained history data, and the total number of times the advertisement was displayed for each channel found from the history data of this time to obtain the number of times the advertisement was displayed for each channel in all the receivers at the time of the calculation, in step 1.

I2. In step 2, the processing/control part 31 examines whether each advertisement stored in the storage part 32 has reached a display deadline of the advertisement or has attained the total number of displays. If it is determined that the advertisement has reached the display deadline (the display period has expired) or has attained the total number of displays, the processing/control part 31 performs the following steps based on the history data.

If data indicating cancellation has been inputted in order to discontinue the advertisement halfway, it is determined that the display period has expired at the point when the data was inputted.

I2a. In step 3, the number of times the advertisement was displayed for each channel is obtained.

I2b. In step 4, a ratio of the total number of display defined by a client (sponsor) and the number of times the advertisement was displayed in each channel.

Also, for example, in the case that the total number of displays of the advertisement in all the receivers exceeds the total number of display defined by the client, or becomes less than the total number of displays defined by the client due to discontinuation of the advertisement or the like, it may be configured to obtain a ratio of the number of times the advertisement was displayed in all the receivers and the number of times the advertisement was displayed in each channel.

I2c. In step 5, the advertisement fee paid by the sponsor is divided and distributed, in accordance with the above ratio, to a company operating each channel.

The storage part 32 of the host device 30 stores a computer program for performing the above steps.

A series of steps from receipt by the host device 30 of a request for an advertisement, through display of the advertisement on each receiver 40, to distribution of advertisement fees to each broadcasting (program) company after displays of the advertisement are completed as described above.

A second example of operations of an advertisement display controlling system will now be described.

In this example, as calculation elements of a priority order of advertisements, a display period (control coefficient Tx), an audience group specifying category (control coefficient Cpq), a predetermined display order (control coefficient Jn), an upper limit display number (control coefficient Ku), a preferred display time (control coefficient Hx), and a taste of an audience (advertisement attribute) (Fx) are used. That is, in the second example, the upper limit display number (control coefficient Ku) is used instead of the averaged display number (control coefficient Ka) used in the first example.

The averaged display number (Ka) of an advertisement used in the above first example is the same value for all the receivers storing the advertisement. That is, it does not take a weight for an audience group to which an audience of each receiver belongs into consideration. For example, in the example of FIG. 1, a sponsor assigns, in the classification Cdx of the audience group specifying element of CM3, 80 to the category Cd1, 10 to the category Cd2, and 10 to the category Cd3. This means that the sponsor attaches importance to an audience group belonging to the category Cd1, an audience group belonging to the category Cd2 and an audience group belonging to the category Cd3 at the ratio of 80 to 10 to 10. However, whether CM3 is stored in a receiver of an audience belonging to the category Cd1 (hobby A) to which importance is attached, or stored on a receiver of an audience belonging to the category Cd3 (hobby C) to which less importance is attached, the averaged display number assigned to each receiver, that is, the initial value of the control coefficient indicating a weight is the same. Therefore, the audience to whom importance is attached and the audience to whom importance is not attached are equally induced to see the advertisement. This is inconvenient when effects and efficiency of an advertisement are taken into consideration.

Therefore, in the second example, the number of displays that takes into consideration the degree of coincidence between an audience group targeted by each advertisement and an audience group of an audience of each receiver, that is, the upper limit display number (control coefficient Ku) is used, instead of the averaged display number (control coefficient Ka).

The second embodiment is similar to the first embodiment except that the upper limit display number (control coefficient Ku) is used instead of the averaged display number (control coefficient Ka). Therefore, if a concept of a method of determining the priority order for displaying advertisements is shown in the form of a table, it will become similar to the table shown in FIG. 1. That is, the table of the second embodiment will be a table in which the calculation element name “averaged display number” and the control coefficient name “Ka” of FIG. 1 are replaced by “upper limit display number” and “Ku.”

Since the operations of the second embodiment and those of the first embodiment of the advertisement display controlling systems have many points in common, only different points are described.

A′. Preparation steps on the receiving side:

The steps of item A′ are those corresponding to the steps described in item A of the above first embodiment (the steps shown in FIG. 4), and the steps similar to the steps described in item A are performed.

The storage part 42 of the receiver 40 stores a computer program for performing the above steps.

B′. A step for analyzing audience data on the broadcasting side:

The steps of item B′ are those corresponding to the steps described in item B of the above first embodiment (the steps shown in FIG. 5), and the steps similar to those described in item B are performed.

The storage part 32 of the host device 30 stores a computer program for performing the above step.

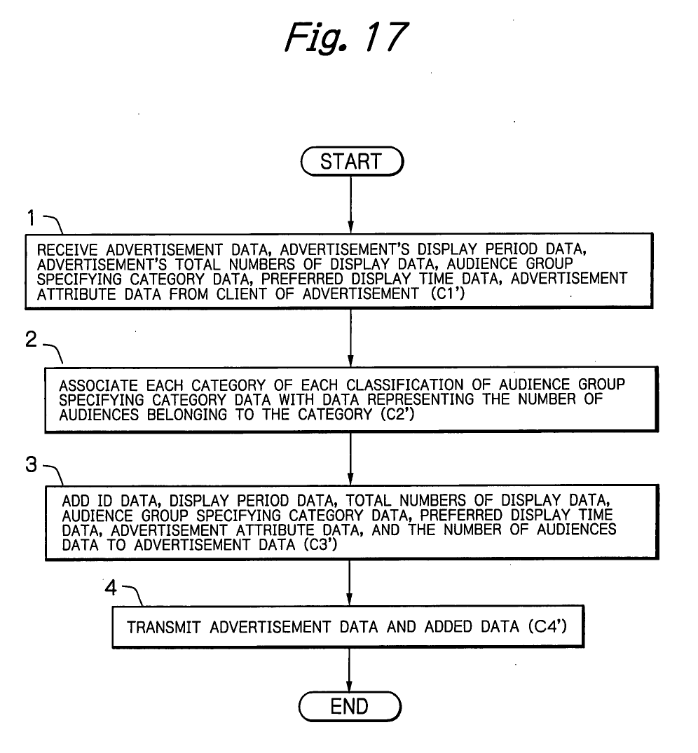

FIG. 17 is a figure corresponding to FIG. 6, and describes steps on the broadcasting side, which will be described in item C′ below, for preparing and transmitting advertisement data.

C′. Steps on the broadcasting side for preparing and transmitting advertisement data:

The steps described here correspond to the steps described in item C of the above first embodiment (the steps of FIG. 6) except some parts.

C1′. As step 1, a step similar to the step described in item C1 of the first embodiment (step 1 of FIG. 6) is performed.

C2′. As step 2, a step similar to the step described in item C2 of the first embodiment (step 2 of FIG. 6) is performed.

C3′. In step 3, the processing/control part 31 adds ID data, display period data, audience group specifying category data (Ca1 to Cd3), preferred display time data (Hx), advertisement attribute data (F1 to F3), the total number of display data and, the number of audience data (Sa1 to Sd3) to advertisement data stored in the storage part 32, and prepares data for transmission to the receiver 40.

In the second embodiment, since the averaged display number is not used as a calculation element of a priority order of advertisements, the step described in item C3 of item C of the first embodiment (step 3 of FIG. 6) is not performed.

C4′. As step 4, a step similar to the step described in item C5 of the first embodiment (step 5 of FIG. 6) is performed. That is, in this step, the processing/control part 31 makes one package by combining a plurality of pairs of the advertisement data and the additional data, and transmits the package from the transmission part 35 to the receiver 40 on occasion or periodically. However, unlike the case of the first embodiment, the additional data does not include averaged display number data, but includes the total number of display data and the number of audience data (Sa1 to Sd3) instead.

The storage part 32 of the host device 30 stores a computer program for performing the above steps.

D′. Steps for receiving, selecting and storing advertisement data on the receiving side:

The steps of item D′ are steps corresponding to the steps described in item D of the above first embodiment (the steps of FIG. 7), and are performed in a similar manner to the steps described in item D.

The storage part 42 of the receiver 40 stores a computer program for performing the above steps.

E′. Steps for preparing an advertisement command signal on the transmitting side:

The steps of item E′ are steps corresponding to the steps described in item E of the above first embodiment (the steps of FIG. 8), and are performed in a similar manner to the steps described in item E.

However, the second embodiment is different from the first embodiment in that the averaged display number (control coefficient Ka) used in the first embodiment is replaced by the upper limit display number (control coefficient Ku). That is, in the second embodiment, the control variable X7 among the control variables Xn is a control variable applied to the control coefficient Ku rather than to the control coefficient Ka.

The storage part 32 of the host device 30 stores a computer program for performing the above steps.

F′. Steps on the receiving side for determining and displaying a priority order of stored advertisement data:

The steps of item F′ are steps corresponding to the steps described in item F of the above first embodiment (the steps of FIGS. 9, 10, 11, 12 and 13), and are performed in a similar manner to the steps described in item F. However, in the second embodiment, the upper limit display number (control coefficient Ku) is used instead of the averaged display number (control variable Ka) used in the first embodiment. Therefore, steps relating to the control variable Ka among the steps described in item F of the first embodiment are different. In the description below, the parts different from the first embodiment will be described in detail.

F1′. In step 1, the processing/control part 31 of the receiver 30 obtains a value of the upper limit display number of each advertisement stored on each receiver, based on the total number of display data (the ordered total number of displays (K)), the audience group specifying category data (Ca1 to Cd3), and the number of audiences data of each category (Sa1 to Sd3) in the additional data of the advertisement data received from the host device 40 and stored in the storage part 32, and determines an initial value of the value representing the weight (control coefficient Ku) for the above value.

The upper limit display number indicates an upper limit of the number of display of each advertisement on each receiver. When the remaining number of display until the upper limit number of displays becomes zero, the control coefficient Ku becomes zero. An advertisement for which the control coefficient Ku has become zero is not displayed any more.

Steps for calculating the upper limit display number for one stored advertisement, which take into consideration a degree of coincidence between an audience group targeted by each advertisement and an audience group of an audience of each receiver, which is one characteristic of the present invention, will be hereinafter described. The steps are performed in the processing/control part 41 of the receiver 40.

F1′a. A value of the control coefficient Cpq for each category to which an audience of the receiver 40 belongs is read out. For example, if the audience belongs to the categories Ca1, Cb1, Cc1 and Cd3, for CM 1, control coefficients 40, 80, 10 and 10 assigned to Ca1, Cb1, Cc1 and Cd3 are read out.

F1′b. The control coefficient Cpq for each category is divided by the total of numerical values (100 in this example) assigned to all the categories included in a classification including the category, thereby finding a weight of the assigned numerical values as a ratio (RCpq). Here, the total of the numerical values assigned to all the categories in each main classification is 100, so that Cpq/100 is the ratio of the assigned numerical values.

Rpq=Cpq/100

Describing with reference to the above example, concerning CM1, the total of four values of ratio is found, namely, Ra1=0.4 (=Ca1/100=40/100) for the category Ca1, Rb1=0.8 for the category Cb1, Rc1=0.1 for the category Cc1, and Rd3=0.1 for the category Cd3.

F1′c. The ordered number of displays of an advertisement (K) is multiplied by each Rpq found in the above step F1′b individually. From this calculation, a value associating the ordered number of displays of an advertisement K with a degree of coincidence of an audience with respect to the advertisement (KRpq) is found.

KRpq=K×Rpq=K×(Cpq/100)

For example, if K of CM1 is 10,000, four values of KRpq, that is, KRa1=4,000 (=10,000×0.4), KRb1=18,000 (=10,000×0.8), KRc1=1,000 (=10,000×0.1) and KRd3=1,000 (=10,000×0.1) are found.

F1′d. The number of all audiences belonging to each category to which the audience of the receiver 40 belongs (or, the number of receivers that stores personal data indicating that the audience belongs to the category) (Spq) is extracted from the additional data. Since the audience of the receiver 40 belongs to a plurality of categories, the number of kinds of Spq is the same as the number of the categories.

In this example, since the audience belongs to the categories Ca1, Cb1, Cc1 and Cd3, the values of Sa1, Sb1, Sc1 and Sd3 are extracted.

F1′e. Each value of KRpq, which is found by associating the degree of coincidence with each category to which the audience belongs in the above step of F1′c, is individually divided by the value of Spq which corresponds to each category and is extracted in the above step of F1′d. By this calculation, a plurality of the numbers of displays of an advertisement (Kc) on each receiver, which takes the number of audiences (the number of receivers) belonging to each category into consideration, is found.

Kc=KRpq/Spq=K×(Cpq/100)/Spq

In this example, four values of Kc are found. For example, if Sa1 is 500, Sb1 is 200, Sc1 is 1,000 and Sd3 is 5,000, 8 (=KRa1/Sa1=4,000/500), 40 (=KRb1/Sb1=8,000/200), 1 (=KRc1/Sc1=1,000/1,000) and 0.2 (=KRd3/Sd3=1,000/5,000) are found as the four values of Kc.

F1′f. The largest value among the plurality of values of Kc calculated in the above step of F1′e is selected, and the value is set to be the final value of Kc. In the above example, the value of Kc is set to 40. The upper limit display number (Ku) that takes a degree of coincidence into consideration is calculated by multiplying this value by an appropriate coefficient (for example, a coefficient indicating room that is statistically found).

Ku=Kc×coefficient=(K×(Cpq/100)/Spq)×coefficient

This is used as the control coefficient Ku indicating a weight of the upper limit display number.

F2′ to F7′. As steps 2 to 8, steps similar to the steps described in items F2 to F7 of item F of the first embodiment (steps 2 to 8 of FIG. 9) are performed.

F8′. As step 9, the processing/control part 41 performs a step similar to the step described in item F8 of item F of the first embodiment (step 9 of FIG. 10). However, control coefficients to be the objects of a control variable application command included in an advertisement command signal received in this step are the display period (control coefficient Tx), the audience group specifying category (control coefficient Ct (Cpq)), the predetermined display order (control coefficient Jn), the upper limit display number (control coefficient Ku), the preferred display time (control coefficient Hx) and the taste of an audience (advertisement attribute) (Fx).

F9′ to F11′. As steps 10 to 16, steps similar to the steps described in items F9 to F11 of item F of the first embodiment (steps 10 to 16 of FIG. 10) are performed.

F12′. In step 17, the processing/control part 41 of the receiver 40 subtracts one from the remaining number of displays of an advertisement designated and displayed by the advertisement designation command (the remaining number of displays until the upper limit display number is reached), and determines whether or not the remaining number of displays is zero. If it is determined that the remaining number of displays is zero, the advertisement data and the additional data of the advertisement are deleted from the storage part 42 in step 18. The advertisement ID data and the history data of the advertisement are retained until they are transmitted to the host device 40. If the advertisement data and the additional data of the advertisement are deleted in step 18, the operation proceeds to step 20.

In step 17, if it is determined that the remaining number of displays is not zero, the operation of the processing/control part 41 proceeds to step 19. In step 19, the weight concerning the remaining number of displays (the control coefficient Ku) for the advertisement is calculated and stored in the storage part 42.

F13′. As step 20, a step similar to the step described in item F13 of item F of the first embodiment (step 20 of FIG. 11) is performed.

F14′. As step 21, a step similar to the step described in item F14 of item F of the first embodiment (step 21 of FIG. 11) is performed.

F15′. Next, in step 22, the processing/control part 41 reads out all the control coefficients Tx, Cpq, Jn, Ku, Hx and Fx for each advertisement. In this embodiment, the audience of a receiver belongs to the categories Ca1, Cb1, Cc1 and Cd3 in the audience group specifying category data as in the first embodiment. Therefore, concerning Cpq, the values of Ca1, Cb1, Cc1 and Cd3 are read out.

F16′. In step 23, the processing/control part 41 reads out the control variable application command from the advertisement command signal, and determines control coefficients anew by applying the variable values (Xn) designated by the control variable application command to the control coefficients (Tx, Cpq, Jn, Ku, Hx and Fx) for that time only. That is, the processing/control coefficient 41 reads out the control variables X1 to X9 from the control variable application command, and multiplies each control variable and its corresponding control variable, thereby calculating new values of control coefficients, Tx′ (=Tx×X1), Cax′ (=Cax×X2), Cbx′ (=Cbx×X3), Ccx′ (=Ccx×X4), Cdx′ (=Cdx×X5), Jn′ (=Jn×X6), Ku′ (=Ku×X7), Hx′ (=Hx×X8) and Fx′ (Fx×X9).

It is desirable that this step is performed before a step for totaling the values of all the coefficients (see step 25, item F18′).

F17′. As step 24, a step similar to the step described in item F17 of item F of the first embodiment (step 24 of FIG. 12) is performed.

F18′. In step 25, the processing/control part 41 totals the values of the control coefficients Tx′, Ku′, Jn′, Hx′ and Fx′ and Ct for each advertisement to find a determination element (Sum). Then, in step 26, based on the determination elements (Sum), the processing/control part 41 determines a final priority order (N) of display of each of the advertisements in the order of larger value of the determination element.

F19′. Then, in step 27, the processing/control part 41 responds to a display command included in the advertisement command signal, reads out advertisement data, which can be displayed within a designated time frame from a designated time, from the storage part 42 in the order of the determined priority order, and outputs the advertisement data from the sound/image information output part 47 to the sound/image output device 48 to display the advertisement.

In addition, if the advertisement is displayed in step 15, the processing/control part 41 reads out advertisement data that can be displayed within the remaining advertisement time frame from the storage part 42 in the order of the determined priority order, and outputs the advertisement data from the sound/image information output part 47 to the sound/image output device 48, from a time immediately after the display of the advertisement in step 15, to display the advertisement.

The processing/control part 41 subtracts a value of the displayed number (usually one) from the value of the remaining number of displays until the upper limit display number is reached with respect to the displayed advertisement, and stores the updated value of the remaining number of display (the remaining number of displays until the upper limit display number is reached) in the storage part 42.

F20′. In step 28, the processing/control part 41 examines the remaining number of displays of each advertisement and, if there is an advertisement for which remaining number of displays is zero, deletes advertisement data and additional data of the advertisement from the storage part 42 in step 29. Note that ID data of an advertisement stored in the storage part 42 and history data concerning display states of the advertisement is retained in the storage part 42 until they are transmitted to the host device 30.

F21′. With respect to the advertisement for which it is determined that the remaining number of displays is not zero in step 28, the processing/control part 41 calculates a value representing the weight (the control coefficient Ku) for the remaining number of displays, and stores the value in the storage part 42 in step 30.

F22′. As step 31, a step similar to the step described in item F22 of item F of the first embodiment (step 31 of FIG. 12) is performed.

F23′. As steps 32 and 33, steps similar to the steps described in item F23 of item F of the first embodiment (steps 32 and 33 of FIG. 13) are performed.

After step 33, the operation step returns to step 4, and the operations similar to the above operations are performed.

The storage part 42 of the receiver 40 stores a computer program for performing the above steps.

G′. Steps on the receiving side for storing history data concerning display of an advertisement:

The steps of G′ are steps corresponding to the steps described in item G of the above first embodiment (the steps of FIG. 14), and are performed in a similar manner to the steps described in item G. However, in the second embodiment, the upper limit display number (control coefficient Ku) is used instead of the averaged display number (control variable Ka) used in the first embodiment. Therefore, steps relating to the control variable Ka in the steps described in item G of the first embodiment are different. In the following description, the different parts are described.

G1′. As step 1, a step similar to the step described in item G1 of item G of the first embodiment (step 1 of FIG. 14) is performed.

G2′. As step 2, a step similar to the step described in item G2 of item G of the first embodiment (step 2 of FIG. 14) is performed.

G3′. After transmitting the ID data and the history data of an advertisement to the host device 30, in step 3, the processing/control part 41 examines whether or not a deletion command is issued to the advertisement stored in the storage part 42, whether or not the remaining display period has reached less than zero (Tr<0), and whether or not the remaining number of displays until the upper limit display number is reached is zero (i.e., whether or not Ku=0).

With respect to an advertisement to which a deletion command is not issued and for which the remaining display period is zero or more and the remaining number of displays is more than zero, the processing/control part 41 maintains the ID data of the advertisement as it stands, and deletes only the transmitted history data from the storage part 42, in step 4.

With respect to an advertisement to which a deletion command is issued, an advertisement for which remaining display period is less than zero, and an advertisement for which remaining number of displays is zero, the processing/control part 41 deletes both the ID data and the history data from the storage part 42, in step 5.

The storage part 42 of the receiver 40 stores a computer program for performing the above steps.

H′. Steps on the transmitting side for processing and controlling history data fed back from a receiver:

The steps of item H′ are steps corresponding to the steps described in item H of the above first embodiment (the steps of FIG. 15), and are performed in the similar manner as the steps described in item H. However, the second embodiment is different in that the upper limit display number (control coefficient Ku) is used instead of the averaged display number (control variable Ka) used in the first embodiment. That is, the second embodiment is different in that the control coefficient Ka for the upper limit display number among the control coefficients to be objects of the control variable application command included in the advertisement command signal is replaced by the control coefficient Ku for the upper limit display number.

The storage part 32 of the host device 30 stores a computer program for performing the above steps.

I′. Steps on the transmitting side for generating statistical data based on history data fed back from the receiving side:

The steps of item I′ are steps corresponding to the steps described in item I of the above first embodiment (the steps of FIG. 16), and are performed in a similar manner to the steps described in item I.

The storage part 32 of the host device 30 stores a computer program for performing the above steps.

A series of steps from receiving of a request for an advertisement by the host device 30, through displaying of the advertisement on each receiver 40, to distributing of advertisement fees to each broadcasting (program) company after completion of display of the advertisement are completed as described above.

Further, in the present invention, kinds of main classifications of audience group specifying category data and sub-classifications (categories) of each main classification can be appropriately increased or decreased if necessary. In addition, restrictions and rules that are applied when a sponsor assigns a numerical value (a weight value) to each category can be changed arbitrarily.

In addition, in the present invention, kinds of time slots of the preferred display time can be increased or decreased appropriately if necessary. In addition, restrictions and rules that are applied when a sponsor assigns a numerical value (a weight value) to each time slot can also be changed arbitrarily.

In addition, in determination of priority orders, there may be a case that a value of a control coefficient of a certain advertisement and a value of a control coefficient of another advertisement become the same and, thus, priority orders of these advertisements become the same. In such a case, the advertisement that was stored earlier is displayed first, or the advertisement that has an ID number, which is attached to the advertisement, higher in place is displayed first, for example.

In addition, in the above description, an example is described in which the transmitting side transmits advertisement data and additional data therefrom and the receiving side selects and stores the advertisement data and the additional data. However, advertisement data and additional data may be stored in a recording medium such as a magnetic disk or an optical disk at the transmitting side, and the recording medium may be passed to the receiving side.

In addition, although an example in which both sounds and images are reproduced is described in the above examples, the advertisement data reproducing method of the present invention can be used for reproducing either sounds or images only.

### EFFECTS OF THE INVENTION

As described above, the present invention is characterized in that a plurality of pieces of advertisement data are stored in an audience side, and, when the stored advertisement data is reproduced by a receiver, weighting for priority of display is executed with respect to each piece of the advertisement data, a priority order for reproducing each piece of advertisement data on the receiver is determined based on the weighting, and, in response to an advertisement data reproduction command, the pieces of stored advertisement data are reproduced in accordance with the priority order.

Therefore, the present invention allows a sponsor to weight an advertisement based on a characteristic inherent in the advertisement, allows respective advertisements to be reproduced with a condition that optimally matches the characteristic inherent in the advertisement before an audience, thereby realizing advertisement effects that the sponsor desires.

In the above manner, the present invention has a technical effect that a publicity effect of an advertisement can be significantly increased compared with a conventional advertisement reproducing technology with which advertisements are reproduced in a fixed order.

Also, in the present invention, since a higher priority order is given to an advertisement with a short display period to read out and display the advertisement preferentially, there is an effect that, even if a display period is short, a predetermined number of displays can be attained.

Also, in the present invention, for each receiver, an averaged display number of each advertisement, which is required on each receiver in order to complete a predetermined total number of displays within a predetermined period, is set, a higher priority order is given to an advertisement which has the large remaining number of displays until the averaged display number of each advertisement is reached, and such an advertisement is read out and displayed preferentially. Therefore, there is an effect that it is possible to attain a predetermined number of displays within a predetermined display period even if the large number of displays remains, and that a situation in which a certain advertisement is displayed too many times in a specific receiver is prevented.

Also, in the present invention, a high priority order is given to an advertisement having a high degree of coincidence between information specifying an audience group targeted by an advertisement and information specifying an audience group to which an audience of a receiver belongs, and such an advertisement is read out and displayed preferentially. That is, since an advertisement that an audience seems to wish to see is displayed preferentially, attention of the audience can be drawn. Therefore, there is an effect that effects and efficiency of an advertisement are extremely improved. Moreover, it is also convenient for an audience because the audience can preferentially see an advertisement that the audience wishes to see or may be interested in.

Also, in the present invention, a predetermined display order of advertisements is defined, a high priority order is assigned to the advertisements in order from the top of the predetermined display order to preferentially read out and display the advertisement that is given a high priority order; and a new predetermined display order is defined after displaying the advertisement(s), a high priority order is again assigned to the advertisements in order from the top of the predetermined display order to preferentially read out and display the advertisement that is given a high priority order. Therefore, attention of an audience can be drawn compared with the case in which advertisements are repeatedly displayed in the same order or the case in which the same advertisements are continuously displayed. Consequently, significantly improved effects and efficiency of an advertisement can be attained.

Also, in the present invention, each advertisement stored on each receiving side is preferentially displayed in a time slot that matches to the lifestyle of an audience targeted by the advertisement and a time slot that conforms to the nature of goods that is publicized by the advertisement. Therefore, an advertisement that an audience seems to wish to see is preferentially displayed in a time slot in which the audience is viewing/listening to a program and attention of the audience can be drawn, whereby significant improvements in the effects and efficiency of an advertisement is attained.

Also, in the present invention, an audience of a receiver can indicate a taste (preference) with respect to an attribute of each advertisement stored on the receiving side, the priority order of displaying advertisements is determined based on the audience-indicated taste with respect to the attributes of the advertisements, and the advertisements are displayed in accordance with the priority order. Therefore, for an audience, since an advertisement suitable for the audience is preferentially displayed, there is an effect that the audience can obtain more of his/her desired information.

Also, in the present invention, for each receiver, an upper limit display number is set, wherein the upper limit display number reflects the degree of coincidence between an advertisement and an audience, mutually supplements shortage of the number of displays on receivers to attain a predetermined total number of displays, and prevents a certain advertisement from being displayed too many times on each receiver; a high priority order is given to an advertisement which has a large remaining number of displays until the upper limit display number is reached; and such an advertisement is read out and displayed preferentially. Therefore, there is an effect that, even if a large number of displays remain, it is possible to attain a predetermined number of displays within a predetermined display period, and a certain advertisement is prevented from being displayed too many times in a specific receiver. In addition, an advertisement that an audience seems to wish to see is displayed many times and the attention of an audience can be drawn. Therefore, there is an effect that the effects and efficiency of an advertisement are extremely improved. In addition, for an audience, since the number of displaying an advertisement suitable for the audience increases and the number of displaying an advertisement not suitable for the audience decreases, there is an effect that the audience can obtain more of his/her desired information.

Also, in the present invention, a priority order which is not biased to a specific determination element can be given by comprehensively taking a plurality of determination elements of a priority order into consideration. Therefore, there is an effect that appropriateness of a priority order given to each advertisement is improved.

Also, in the present invention, display states of an advertisement on a receiver is confirmed on a host side, and display of an advertisement stored on each receiver is controlled from the host side according to the display states. That is, it is possible to apply advertisement display control of higher accuracy to all receivers from the host side. Therefore, for example, in the event of an unexpected accident, even if the total number of displays ordered by a sponsor cannot be attained within a predetermined period by an ordinary advertisement displaying operation, the required number of displays can be attained within the predetermined period by controlling the receiver from the host side.

Also, in the present invention, it is possible to designate an advertisement that should be displayed most preferentially and, if the designated advertisement is stored on a receiving side, the receiver is controlled such that the advertisement is displayed most preferentially. Therefore, if a sponsor designates a date, a time slot, a program, etc., that an advertisement is to be displayed, the advertisement can be displayed as designated. Thus there is an effect that the sponsor can be satisfied, and there is an effect that an advertisement frame can be sold more easily. In addition, there is an effect that, if it is necessary to display a certain advertisement urgently, the advertisement can be easily inserted in a desired advertisement frame.

1. An advertisement data reproducing method wherein advertisement data for each of a plurality of advertisements is stored at a viewer/listener side and the advertisement data is reproduced on a receiver at the viewer/listener side, wherein, at the viewer/listener side, said advertisement data reproducing method comprising:
storing the advertisement data of each of the advertisements to which the following has been added: (i) time slot data representing one or more time slots; and (ii) data representing each value of a coefficient representing a weight assigned to each time slot represented by the time slot data;
determining a time slot to which a present time of day belongs;
for the advertisement data of each advertisement, reading out the value of the coefficient representing the weight assigned to a time slot which corresponds to the time slot determined by said determining of the time slot;
based on the value of the coefficient read out by said reading out of the value of the coefficient, determining a priority order for reproducing, on the receiver, the advertisement data of each advertisement;
selecting the advertisement data of one or more advertisements to be reproduced on the receiver from the stored advertisement data of the plurality of advertisements, based on the priority order determined by said determining of the priority order; and
reproducing the advertisement data of one or more advertisements, selected by said selecting of the advertisement data, on the receiver in accordance with the priority order, wherein:
the time slots, which are time intervals in a day, are predefined by partitioning a time of day into a plurality of time intervals;
the time slot data represents at least one time slot, selected from the predefined time slots, at which the advertisement data of the advertisements is desired to be preferentially reproduced on the receiver; and
a greater weight is assigned to a time slot having more importance than a time slot having less importance.

2. An advertisement data reproducing apparatus for storing advertisement data for each of a plurality of advertisements at a viewer/listener side, said advertisement data reproducing apparatus comprising:
a receiver for reproducing the advertisement data at the viewer/listener side;
means for storing the advertisement data of each of the advertisements to which the following has been added: (i) time slot data representing one or more time slots; and (ii) data representing each value of a coefficient representing a weight assigned to each time slot represented by the time slot data;
means for determining a time slot to which a present time of day belongs;
means for reading out, from the advertisement data of each advertisement, the value of the coefficient representing the weight assigned to a time slot which corresponds to the time slot determined by said means for determining the time slot;
means for determining, based on the value of the coefficient read out by said means for reading out the value of the coefficient, a priority order for reproducing, on said receiver, the advertisement data of each advertisement;
means for selecting the advertisement data of one or more advertisements to be reproduced on said receiver from the stored advertisement data of the plurality of advertisements, based on the priority order determined by said means for determining the priority order; and
means for reproducing the advertisement data of one or more advertisements, selected by said means for selecting the advertisement data, on said receiver in accordance with the priority order, wherein:
the time slots, which are time intervals in a day, are predefined by partitioning a time of day into a plurality of time intervals;
the time slot data represents at least one time slot, selected from the predefined time slots, at which the advertisement data of the advertisements is desired to be preferentially reproduced on said receiver; and
a greater weight is assigned to a time slot having more importance than a time slot having less importance.

3. A storage medium for storing a computer program which enables a computer to carry out an advertisement data reproducing procedure in which advertisement data for each of a plurality of advertisements is stored at a viewer/listener side and the advertisement data is reproduced on a receiver at the viewer/listener side, wherein, at the viewer/listener side, said advertisement data reproducing procedure comprising:
storing the advertisement data of each of the advertisements to which the following has been added: (i) time slot data representing one or more time slots; and (ii) data representing each value of a coefficient representing a weight assigned to each time slot represented by the time slot data;
determining a time slot to which a present time of day belongs;
for the advertisement data of each advertisement, reading out the value of the coefficient representing the weight assigned to a time slot which corresponds to the time slot determined by said determining of the time slot;
based on the value of the coefficient read out by said reading out of the value of the coefficient, determining a priority order for reproducing, on the receiver, the advertisement data of each advertisement;
selecting the advertisement data of one or more advertisements to be reproduced on the receiver from the stored advertisement data of the plurality of advertisements, based on the priority order determined by said determining of the priority order; and
reproducing the advertisement data of one or more advertisements, selected by said selecting of the advertisement data, on the receiver in accordance with the priority order, wherein:
the time slots, which are time intervals in a day, are predefined by partitioning a time of day into a plurality of time intervals;
the time slot data represents at least one time slot, selected from the predefined time slots, at which the advertisement data of the advertisements is desired to be preferentially reproduced on the receiver; and
a greater weight is assigned to a time slot having more importance than a time slot having less importance.
